(19) United States
(12) Patent Application Publication
(10) Pub. No.: US 2015/0360775 A1
(43) Pub. Date: Dec. 17, 2015

(54) VERTICAL TAKE-OFF AND LANDING FLIGHT VEHICLE

(71) Applicant: Yusho ARAI, (US)

(72) Inventor: Yusho ARAI, Tokyo (JP)

(21) Appl. No.: 14/768,338

(22) PCT Filed: Oct. 29, 2014
(86) PCT No.: PCT/JP2014/079382

§ 371 Date: Aug. 17, 2015

(30) Foreign Application Priority Data
Oct. 30, 2013 (JP) 2013-237370

(51) Int. Cl. B64C 29/00

(52) U.S. Cl. CPC B64C 29/0041; B64C 29/0075

(57) ABSTRACT

The invention provides, in vertical and oblique lift and descent, horizontal flight and hovering, for maintenance of attitude of an airframe, using a single wing, large blades and a single large rudder, under divergent airflow. To change attitude in hovering from horizontal to vertical, in case three wings are provided on the airframe, the output of an engine mounted on a wing at the front part of the airframe is increased, the lifting power is increased and the front part of the airframe rises from the horizontal. Then output of an engine of the rear part of the airframe is reduced, and the lifting power of the rear part of the airframe is diminished. When an angle of the airframe is increased, a second wing located in the central part of the airframe is moved to a 90 degrees vertical direction and an output occurs so that the altitude of the airframe does not drop.

### TECHNICAL FIELD

The present invention relates to a vertical takeoff and landing flying vehicle having wind-jet devices installed to a plurality of angle adjustable wings mounted on the upper part of the aircraft, and particularly relates to the vertical takeoff and landing aircraft, including small to large aircrafts, capable of obtaining safe attitude control even in air-turbulence such as downdraft and so forth or under any flight conditions including such as cruising in higher altitude than 10,000 m, hovering in high altitude, takeoff from and landing on water surface, high-speed flight in extremely low altitude such as 10 m, flying zigzag, vertical takeoff and landing, Harrier Flight and so forth, and adopting a hybrid system providing low engine noise.

### TECHNICAL BACKGROUND

Osprey (Bell Boeing C-22 Osprey) that is not capable of flying in high altitude higher than 5000 m and in high-speed faster than 600 km/hour but capable of vertical takeoff and landing, hovering and flying in low-speed and in low altitude is known as a conventional aircraft capable of vertical takeoff and landing.

Compared to a tandem-rotor helicopter, e.g. CH-46 (Boeing Vertol CH-46 Sea Knight), the flying range thereof is more than 4 times, the speed therefor is twice as high, the load capacity thereon is three times more so that it can be superior to CH-46 in almost all aspects. In addition, Osprey is capable of receiving air-to-air refueling so that the flying range thereof can be expanded up to 1100 km and allows making a long flight.

Meantime, an aircraft like Osprey having right-and-left two engines that are operative switching from horizon to vertical can make vertical takeoff and landing by changing the engines to the vertical direction and horizontal flight by changing the engines to the horizontal direction.

The direction of the airframe of this vertical takeoff and landing aircraft can be controlled by changing the rudder angle in the rear of airframe during horizontal flight and further nose-up and nose-down can be achieved by the operation of the wind jet device and the flap installed to the wing.

For example, the engine faces toward the flying direction during horizontal flight and the wind is jetted toward the rear of the airframe. Then, the air flows parallel to the airframe and the wings toward the rear of the airframe so that the flap can be fully operative and control of the stable flying attitude can be archived during the horizontal flight with constant speed.

Further, the aircraft having a large propelling machinery installed in the airframe, fixed one or two wing-plane-fixed-wings fixed horizontally, and a vertical tail or a horizontal tail and the tail rotor type rudder is known.

### SUMMARY OF INVENTION

### Problems to be Solved by the Invention

However, there are the following problems to be solved for such vertical takeoff and landing aircraft.

(1) During the transition from the horizontal flight state to the hovering state or the nose-down state, or from vertical takeoff and landing or the hovering state to the horizontal flight state and the zigzag flight and so forth, the jet-wind from the engine is jetted strongly downward to the wing during the flight state until the engine's angle becomes parallel to the wing so that the thrust force is erased, a turbulence takes place, winds from a variety of directions impact further, and an unstable attitude can be induced.

(2) The rudder is constructed at the rear end position of the airframe from the position where the engine is installed and the outside tip of the wing and in addition, where is the central rear part of the airframe away from the right rear end of the right-and-left wings where engines are installed and is outside of the jet-stream provided from the propeller during each flight state such as hovering and horizontal flight so that it can be problem that the jet-stream flows toward underside of the airframe rather than toward the rear of the airframe and will not reach to the rudder at all so as to make a difficult direction control.

(3) Heavy engines are installed at the outside tip end of the wing so that the barycenter of airframe spreads to right-and-left from the center of airframe and further gravity is added by up-and-down movement of the tip end of right and left wings during flight and it can be problem that particularly control of up-and-down movement of wings can be difficult due to air-streams from a variety of directions and during a zigzag flight. For example, providing down stream to the right engine, the airframe tilts toward lower right, but providing a heavy blade having a large diameter, it can be problem that the opposite left wing cannot be lifted immediately to recover and adjust the right-and-left balance of the airframe. Further, no center axis of the air frame exists so that it can be problem that the stable attitude cannot be maintained against turbulences from a variety of directions including front-and-back and right-and-left directions and diagonal directions thereof.

(4) Further, the engines cause noises loudly so that vertical takeoff and landing, low altitude flight, night time or 24-hour vertical takeoff and landing operations cannot be accepted.

(5) Further, the large blade having a large radius of rotation is adopted so that the jet-air-speed from the blade is relatively weak and low compared to a jet-engine or a high-speed rotation turboprop for an aircraft and therefore, no lower altitude flight than 10 m with a low-speed, 30 km/hour, is possible, no rise to high altitude (e.g., higher than 5000 m) is possible, no hovering at high altitude with low air-density or no high-speed cruise flight at 700 km/hour is operable.

(6) Further, it is problematic that in the hovering state, control of attitude of the airframe cannot be performed at will. For example, it is problematic that the airframe in the horizontal attitude and the hovering state cannot be maintained in the other attitude than horizontal attitude, e.g., the attitude in which the front of the airframe lifts 45 degree upward to the slope landing area and the airframe in the horizontal attitude and the hovering state cannot take vertically and fixedly the other attitude than the horizontal attitude, e.g, as if the airframe is attached to the wall of high rise building.

(7) It is problem that the airframe cannot be subjected to cruise and hover (making Harrier Flight) at 10000 m altitude.

(8) It is problem that a number of wings and the plan area thereof are small and providing the engine is in trouble, no alternative thrust mechanism may work and further, no gliding flight is operable.

(9) It is not operable for air transportation of a large number of people and a large quantity of materials. For example, it is not operable for mass air transportation in a short period of time from a coastal fishing ground to a fish market in the city. Further, it is not operable for mass air transportation of the products in a short period of time from a sprawling farm land to a focus of the farm products. Further, it is not operable for direct touring flight from a city to see the tourist spots or direct vertical takeoff and landing tour by a large aircraft from lake or ocean surface or accommodation facilities.

(10) Further, regarding with a plane fixed type vertical takeoff and landing aircraft having one or two vertical tail or horizontal tail and/or tail rotor, it is problem that the unintended and unstable attitude of the airframe takes place due to side wind or downforce turbulence.

(11) Further, regarding with a plane fixed type vertical takeoff and landing aircraft having one or two vertical tails or horizontal tails and/or tail rotors, it is problem that the normal flight attitude is controlled by the rudder including the vertical tail, the horizontal tail and the tail rotor and so forth that are being impacted by the a variety of winds but in the case of defect and so forth relative to the rudder, the attitude control won't be operable.

(12) Further, regarding with a plane fixed type vertical takeoff and landing aircraft having one or two vertical tails or horizontal tails and/or tail rotors, it is problem that control of stable flight is difficult because no method for controlling the attitude by single or two thrust modules is available.

(13) Further, a purity of engines installed to the conventional airframe do not operative to individually function thrust force; in addition, downwind from the thrust module during hovering or natural downforce (downward airstream) strikes the plan fixed type wing installed to the airframe so that the turbulence takes place in the range from side surface to backside of the wing and the airframe attitude will be unstable; and further, the large rudder is installed to the rear end of the airframe so that the airframe will be unstable against side wind due to such large rudder and a variety of attitude controls thereof can be difficult despite changing the thrust force from only one or two thrust modules (engine and/or propeller).

### Purpose of the Present Invention

Accordingly, the purpose of the present invention is to provide a vertical takeoff and landing aircraft capable of assuring a safe attitude control despite any flight conditions and turbulence including down airstream and so forth, making no noise when takeoff and landing and capable of low-speed flight/high-speed flight/hovering in a low altitude and low-speed flight/high-speed flight/hovering in a high altitude.

Further, the another purpose of the present invention is to provide a vertical takeoff and landing aircraft capable of controlling precious attitude under side wind or turbulence by installing a plurality of thrust modules that allows controlling preciously airframe even with a small tail rotor or a small rudder or even without the rudder and discriminating the thrust force of each thrust machine respectively by installing 2 and more thrust machines to each wing, and by eliminating the large vertical tail or horizontal tail.

### Means for Solving the Problem

To achieve the above purposes, an vertical takeoff and landing aircraft of the present invention comprises: movable wings comprising a plurality of wings, wherein the plan part of each wing is movable from horizontal to vertical direction installed on the airframe; a jet-wind generation device so as to generate jet-wind is installed to the plurality of wings; a rudder so as to control the moving direction of the airframe and a flap so as to control up-and-down direction of the airframe are installed to a proximity right behind the jet-wind generation device; each sensor so as to detect the direction/rising/down/rotation/position/airframe attitude/speed/altitude/distance to an obstacle is installed to each movable wing; and a control module so as to conduct the attitude control based on the detected data by each sensor is installed to the airframe.

The improvement comprises that the jet-wind generation device is installed between the airframe and the plural wing tips.

Further, the improvement comprises that the jet-wind generation device is a hybrid type reciprocating engine or a turboprop jet engine.

Further, the improvement comprises that the jet-wind generation device comprises a hybrid in which each engine and motor are used together.

Further, the improvement comprises that it is a parallel system in which the motor alone can be operable in a short period of time.

Further, the improvement comprises that the plural wings are operative independently and respectively from other wing.

Further, the improvement comprises that the jet-wind generation devices installed to the plural wings are operative independently and respectively from other wing.

Further, the improvement comprises that the plural wings are operative in the 100 degree angle upward from the horizontal direction to the vertical direction

Further, the improvement comprises that the plural wings are operative in any angle with an individual angle.

Further, the improvement comprises that the sensors comprises GPS, a gyro sensor, a proximity sensor, a altitude sensor, and a speed sensor.

Further, the improvement comprises that the airframe comprises an imaging device that can take momentarily understandable images all around the airframe.

Further, the improvement comprises that each engine is a high rotative speed engine for an aircraft.

Further, the improvement comprises that the airframe comprises batteries, wherein the batteries can be charged by the generator installed to each engine, generator-charge system, or by a plug-in charger on the ground, plug-in charging system.

Further, the improvement comprises that a number of installed wings is at least one or two and at most 3-5.

Further, the improvement comprises that, in the case of 3 and more, the wing installed in the center of the airframe is shifted 1-2 m toward either front or rear direction.

Further, the improvement comprises that a small vertical tail rudder and/or a small tail rotor is installed behind the jet-wind generation device in the very front wing and in the very rear.

Further, the improvement comprises that controlling the airframe attitude, moving direction and moving can be conducted by controlling thrust forces of the wings and the plural jet-wind generation devices.

Further, the improvement comprises that retractable wings are installed to the side of moving vehicles including a bus and an automobile and so forth.

### Effects of the Invention

According to the present invention, an vertical takeoff and landing aircraft comprises: movable wings that constitutes a plurality of wings, wherein the plan part of each wing is movable from horizontal to vertical direction installed on the airframe; wherein a jet-wind generation device so as to generate jet-wind is installed to the plurality of wings; a rudder so as to control the moving direction of the airframe and a flap so as to control up-and-down direction of the airframe are installed to a proximity right behind the jet-wind generation device, each sensor so as to detect the direction/rising/down/rotation/position/airframe attitude/speed/altitude/distance to an obstacle is installed to each movable wing, and a control module so as to conduct the attitude control based on the detected data by each sensor is installed to the airframe so that the aircraft can assure a safe attitude control despite any flight conditions and turbulence including down air-stream and so forth.

Further, the jet-wind generation device comprises the hybrid type reciprocating engine or the turboprop jet engine and a hybrid constitution combined with the motor so that no noise will be caused when takeoff and landing and low-speed flight/high-speed flight/hovering in a low altitude and low-speed flight/high-speed flight/hovering in a high altitude can be achieved.

Further, the aircraft would be large and capability and controllability thereof would be are improved dramatically with a variety of sensors and many engines/wings/rudders/flaps so that the high-speed train requiring a vast infrastructure investment may not be needed and a safe aircraft can be provided as a moving vehicle in near future.

Further, when takeoff from water surface and the airframe is in the horizontal state, the contact area between the airframe body and water surface is maximal and should the body rises with the horizontal attitude, the surface tension is maximal so that a large energy is needed for the body to leave water surface, but providing the front of the airframe body is lifted 20 degree, 30 degree or 45 degree, the contact area between the airframe body and water surface decreases and also the surface tension between the airframe body and water surface decreases and then rising from water surface will be easy.

Further, the airframe in the hovering state is maintained as the horizontal state, but can change the attitude thereof to the vertical direction to attach to the wall to the building for the rescue from the high rise building and to the required attitude of the airframe body in vertical or tilted attitude for the rescue or other works in the tilted area of mountains and so forth.

Further, as a common-sense theory, risk management capability for the aircraft having a plurality of wings having an engine installed to each wing, can increase remarkably based on controlling each wing relative to the three wings aircraft compared to risk management capability of the single wing aircraft against sudden turbulence so-called downforce during normal air-cruise.

Further, the inventor confirmed using the scale model, in which when all engines of the aircraft having a plurality of wings having an engine installed to each wing (e.g, experimental example with three wings), are stalled during flight, a gliding flight was operable.

Further, one of purposes of the present invention is to ensure high buoyancy relative to the aircraft with a plurality of wings having an engine installed to each wing and such high buoyancy allows the aircraft to fly 5-10 m above water surface and in-between trees and 10 m above the farm land, i.e., in very low altitude with a high-speed.

Further, relative to the aircraft with a plurality of wings having an engine installed to each wing, a aircraft having 4 engines with two wings has absolutely more thrust force than the aircraft having two engines with one wing and the high-speed flight is operative, and providing three wings, the aircraft therewith can fly in higher speed than one with two wings and can be more operative to keep the operative airframe attitude.

Further, according to the present invention, as the constitution set forth above, a vertical tail rudder and the horizontal tail wing and/or a tail rotor are made in a small size and/or eliminated so that the airframe can maintain the best attitude regardless turbulence including side wind and upstream or downstream during runway takeoff and landing or vertical takeoff and landing takeoff and landing.

In addition, a plurality of thrust machines is installed so that stable attitude control can be turned in reality by the thrust machines.

### BRIEF DESCRIPTION OF THE DRAWINGS

FIG. 1 is a schematic view illustrating the entire constitution of an aircraft having one wing of first Embodiment.

FIG. 2 is a schematic front view illustrating an aircraft having one wing of first Embodiment.

FIG. 3 is a schematic view illustrating the hovering state in which the wing angle of the aircraft having one wing of first Embodiment is changed.

FIG. 4 is a side view illustrating a constitution of an aircraft having one wing of first Embodiment in which the wing plan is changed and a rudder and a horizontal tale wing are installed to the rear of the airframe.

FIG. 5 is a side view illustrating a constitution of a rudder position and a flap position of an aircraft having one wing of first Embodiment.

FIG. 6 is a schematic view of the entire constitution of a aircraft having one wing of second Embodiment.

FIG. 7 is a side view illustrating the mounting position of wings of a aircraft having two wings of second Embodiment.

FIG. 8 is a front view illustrating a horizontal flight state of the aircraft having two wings of second Embodiment.

FIG. 9 is a side view illustrating the hovering state in which the wing angle of the aircraft having one wing of the first Embodiment is changed.

FIG. 10 is a view illustrating a state in which the engine mounting angle has a slight angle relative to the aircraft having two wings of second Embodiment.

FIG. 11 is a view illustrating a hovering state in which the front and rear wing mounting position relative to the aircraft having two wings of second Embodiment.

FIG. 12 is a front view illustrating the state in which positions of front and rear wings the aircraft having two wings of second Embodiment are movable.

FIG. 13 is a plan view illustrating the entire constitution of a aircraft having three wings of third Embodiment.

FIG. 14 is a side view illustrating a horizontal flight state of the aircraft having three wings of third Embodiment.

FIG. 15 is a side view illustrating a hovering state of the aircraft having three wings of third Embodiment.

FIG. 16 is a side view illustrating a vertical hovering state of the aircraft having three wings of third Embodiment.

FIG. 17 is a view illustrating the aircraft having three wings of third Embodiment, which landed on the tilted ground and the balance thereof is preventing slipping down.

FIG. 18 is a schematic view illustrating the aircraft having three wings of third Embodiment is moving the wings thereof back-and-forth relative to the airframe.

FIG. 19 is a view illustrating a moving device to move vertically the main wing installed to the top of the airframe from the horizontal plane.

FIG. 20 is a perspective view illustrating the base module of the wing inserted to the groove.

FIG. 21 is a side view illustrating the base module of the wing inserted to the groove.

FIG. 22 is a view illustrating the positional relationship in between a wing mounting module inserted and engaged to a wing support module, a gear with motor installed to the wing mounting module, a gear with motor to change the wing angle by engaging with the motor and a gear with motor to move the wing position back and forth.

FIG. 23 is a side view illustrating the wing mounting module and each motor in FIG. 22.

FIG. 24 is a side view illustrating the state in which each motor is mounted to the moving device.

FIG. 25 is a perspective view illustrating the moving device and the mounting state of each motor.

FIG. 26 is a view illustrating the state in which the wing is mounted to the moving device and becomes operative.

FIG. 27 is a view illustrating behavior of each wing when the airframe is changed with any angle from the horizontal plan to the vertical state.

FIG. 28 is a view illustrating a jet system.

FIG. 29 is a schematic plan view illustrating the hovering state when 4 wings are applied.

FIG. 30 is a schematic plan view illustrating the horizontal flight when 4 wings are applied.

FIG. 31 is a schematic side view illustrating the horizontal flight when 4 wings are applied.

FIG. 32 is a schematic plan view illustrating the hovering state when 4 wings are applied.

FIG. 33 is a schematic side view illustrating the horizontal flight when 5 wings are applied.

FIG. 34 is a schematic view illustrating that an aircraft having 5 wings conducts takeoff and landing on water and is in the hovering attitude.

FIG. 35 is a schematic view illustrating that the airframe having 3 wings, the front and rear wings with the small rudder is rotating horizontally around the center axis of the airframe during hovering.

FIG. 36 is a schematic view illustrating that the airframe having 3 wings and the front and rear wings with the small rudder is rotating horizontally around the front part of the airframe as the axis during hovering.

FIG. 37 is a schematic view illustrating that the airframe having 3 wings and the from and rear wings with the small rudder is doing parallel moving while changing the moving trail without changing the airframe attitude in the case of moving straight forward.

FIG. 38 is a schematic view illustrating the parallel rising when the airframe with the movable wing rises while keeping a horizontal attitude.

FIG. 39 is a schematic side view illustrating an airframe in which a tail wing and a vertical rudder from a plurality of movable wings.

FIG. 40 is a schematic side view illustrating an airframe in which small rudders are installed to a plurality of movable wings, the front wing and the rear wing.

FIG. 41 is a schematic front view illustrating an alternative Embodiment in which thrust modules are installed to a plurality of variable and movable double wings.

FIG. 42 is a schematic side view illustrating an alternative Embodiment in which a small rudder is installed to the right behind the engine of a plurality of variable and movable double wings.

FIG. 43 is a schematic top view of the airframe in the hovering state, illustrating an alternative Embodiment in which thrust modules are installed to a plurality of variable and movable double wings.

FIG. 44 is a schematic side view illustrating an alternative Embodiment in which the folding variable and movable wings installed to a bus are opened.

FIG. 45 is a schematic front view illustrating an alternative Embodiment in which the folding variable and movable wings are installed to a bus.

FIG. 46 is a schematic top view illustrating an alternative Embodiment in which the folding variable and movable wings are installed to a bus.

FIG. 47 is a schematic front view illustrating an alternative Embodiment in which the folding variable and movable wings are installed to a bus.

FIG. 48 is a schematic front view illustrating an alternative Embodiment in which the retractable, variable and movable wings are installed to a passenger car.

FIG. 49 is a schematic front view illustrating an alternative Embodiment in which the retractable and variable wings are installed to a passenger car.

FIG. 50 is a schematic front view illustrating an alternative Embodiment in which the retractable and variable wings are installed to a passenger car.

FIG. 51 is a schematic front view illustrating an alternative Embodiment in which the retractable, variable and movable wings installed to a passenger car are retracted.

FIG. 52 is a schematic perspective view illustrating an alternative Embodiment in which the retractable and variable wings are installed to a flying boat.

### THE BEST MODE OF THE PRESENT INVENTION

Hereafter, the inventor sets forth the best mode of Embodiment of the present invention referring to FIGs.

### First Embodiment

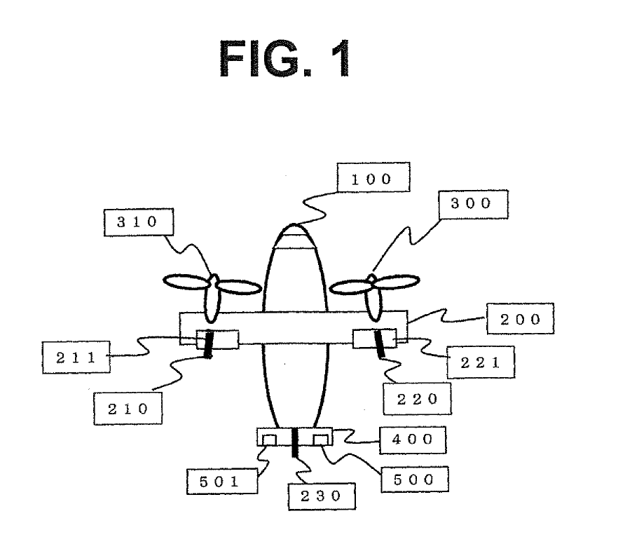

FIG. 1 is a schematic view illustrating the constitution of an flying device (hereafter aircraft) having one wing of first Embodiment.

Referring to FIG. 1, the aircraft comprises; one main wing 200 that is installed on the top of the airframe 100, engines 300, 310 for propeller, which are fixed around the center of each right and left wing of the main wing 200, flaps 211, 221 that are installed to the right behind the engines 300, 310 and are operative to control nose-up and nose-down of the airframe 100, rudders 210, 220 that are installed to the right behind the engines 300, 310 and are operative to control the moving direction of the airframe 100, a rudder 230 that is installed to the rear of the airframe 100, and a horizontal tail wing 400 having flaps 500, 501 are installed.

According to the above constitution, the central axis of engines 300, 310 are fixedly installed as facing outside with less than 3 degree angle from the central axis of the airframe 100. In addition, the main wing 200 pivots with 100 degree angle from horizontal direction to vertical direction.

In addition, engines 300, 310 are installed around the center of each right and left wing of the main wing 200. That is, if the mounting position of wings is near the center instead of the edge, the balance is centered to the center of the airframe because the up-and-down movement balance of the right and left wings can be easily balanced. In addition, the horizontal tail wing 400 and the rudder 230 having flaps 500, 501 at the rear end of the airframe are installed are installed so that control of attitude can be improved.

Further, engines 300, 310 are propeller engines as an example, but it is not limited and may be jet-engines.

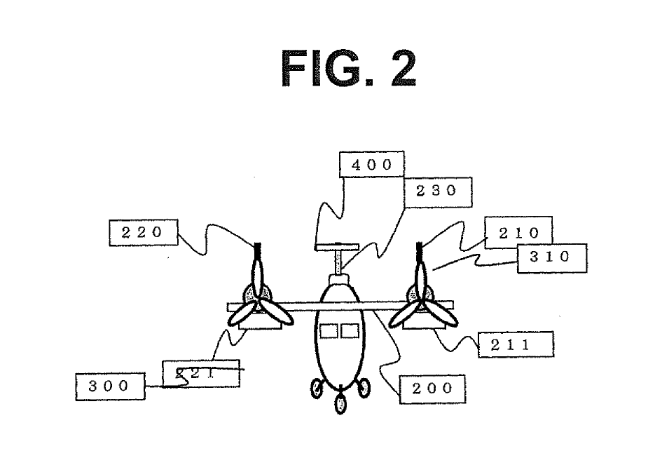

FIG. 2 is a schematic front view (a from the front side of an airframe) illustrating a aircraft having one wing of the first Embodiment.

Referring to FIG., rudders 210, 220 and flaps 211, 221 are installed right behind engines 300, 310 installed to one main wing 200. That is, the rudders 210, 220 and the flaps 211, 221 are installed right behind the engines 300, 310 so that the rudders 210, 220 and the flaps 211, 221 can be effectively operative because jet-wind from the engines 300, 310 strikes the rudders 210, 220 and the flaps 211, 221. In this case, flaps 500, 501 installed to the rudder 230 and the tail wing 400 installed in the rear of the airframe 100 conduct an auxiliary operation of the rudders 210, 220 and the flaps 211, 221.

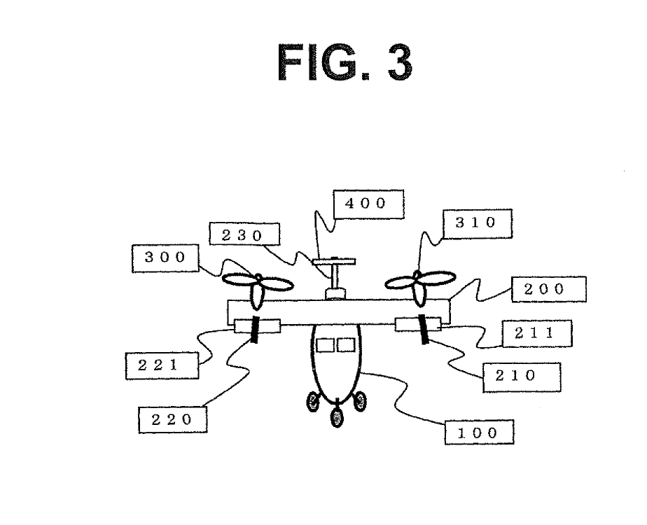

FIG. 3 is a schematic view illustrating the hovering state that is achieved by moving the angle of the main wing 200 of the aircraft 100 to the vertical direction.

Referring to FIG., propeller engines 300, 310 are installed to the main wing 200 mounted to the airframe 100 and the central axis of engines 300, 310 is installed as inclining toward the inside relative to the axis of the airframe 100. Then, when the main wing 200 pivots to the vertical direction, the rudders 210, 220 and the engines 300, 310 fixed to the main wing 200 also move to the same direction relative to the main wing 200. The flaps 220, 221 of the main wing 200 are parallel to the jet-wind and wind resistance will be minimal. The rudders 210, 211 are always right behind the engines 300, 310 and are installed in the center of the thrust wind jetted from engines 300, 310. Accordingly, inclined jet-wind is being jetted outward and downward from the airframe.

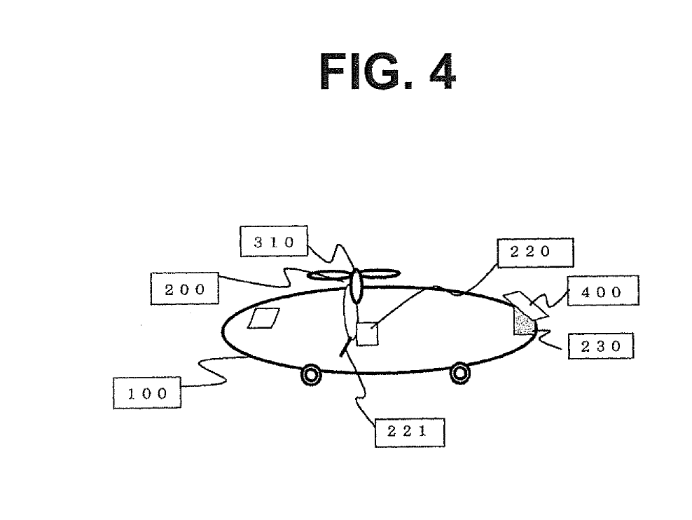

FIG. 4 is a schematic side view of the aircraft in FIG. 3.

Referring to FIG., the engine 300 (310), the rudder 210 (220) and the flap 211 (221) move monolithically and in conjunction with the angle of the main wing 200 in the vertical direction and the horizontal direction.

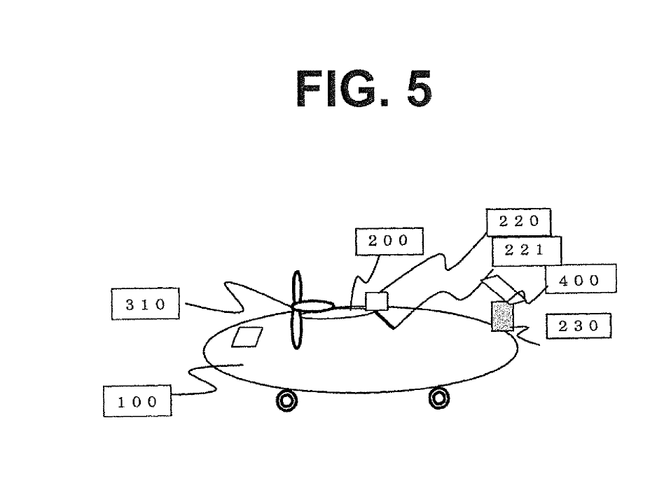

FIG. 5 is a schematic side view of the aircraft 100 in FIG. 1 in the horizontal flight. Referring to FIG., the rudder 210 (220) and the flap 211 (221) are installed right behind jet-wind from the engine 310 (300) for the propeller so that the jet-wind strikes without loss and accordingly a control in forward direction and an nose-up and nosedown control can be easily conducted.

That is, an engine is installed around the center of right and left wings fixed on the top of the airframe and the facing direction of the engine and the wing are operative in conjunction and movable, the engine, the rudder and the flap are installed to the right and left movable wings and the engine, the rudder and the flap are operative in conjunction with and corresponding to flight condition so that the jet-wind can be always operative to control the attitude and control the direction.

In addition, the flap is installed near the wing having the engine and the rudder is installed to the wing right behind the engine fixed to the wing so that the rudder can be in place always in the center of jet-wind in any attitudes thereof. Further, the wing is always parallel to the jet-wind jetted from the engine in any states including runway takeoff and landing, vertical takeoff and landing, nose-up gliding, nose-down gliding or Harrier Flight and so forth. The engine and the flap are operative in conjunction so that the wing is being kept in the least wind resistance and jet-wind flows through the place where the flap is most easily functional.

According to the conventional vertical takeoff and landing aircraft, when the aircraft is hovering (Harrier Fight or air flight close to), the air jetted from the engine strikes right downward under the aircraft so that the aircraft in Harrier Flight cannot be strongly controlled even due to slight side wind. In addition, the heavy engine is installed to the tip end of the aircraft so that the attitude can be further troubled. In contrast, the vertical takeoff and landing aircraft according to the present Embodiment, the air outlet from the engine is fixedly installed outward outside in less than 3 degree so that the jet-wind can be jetted to right outside and obliquely downward or left outside and obliquely downward and therefore the airframe can be assured in the stable attitude that is hardly impacted by side wind.

Accordingly, a variety of stable flights including horizontal rotation, rotation, back-and-forth and right-and-left movements can be achieved and high-speed flight as if an airplane can be provided in the horizontal flight, an airplane mode or helicopter mode can be selected as the optimal runway takeoff or vertical takeoff and landing during takeoff and landing, and safe aircraft can be provided.

### Second Embodiment

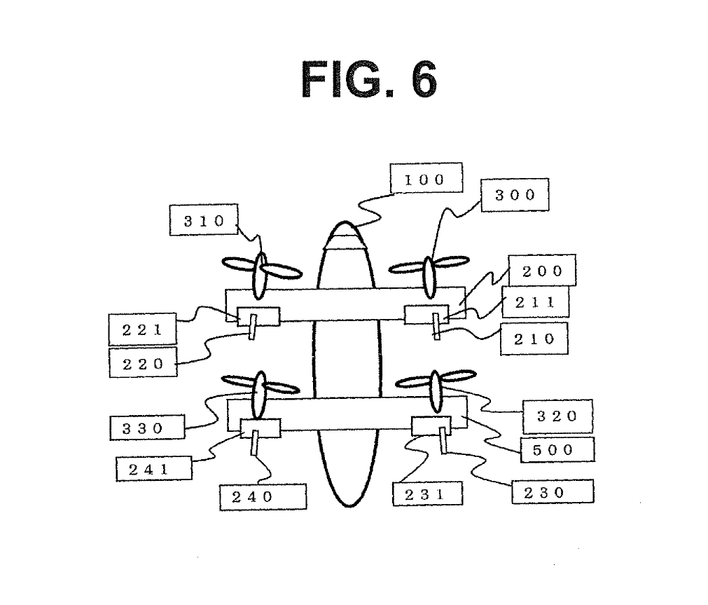

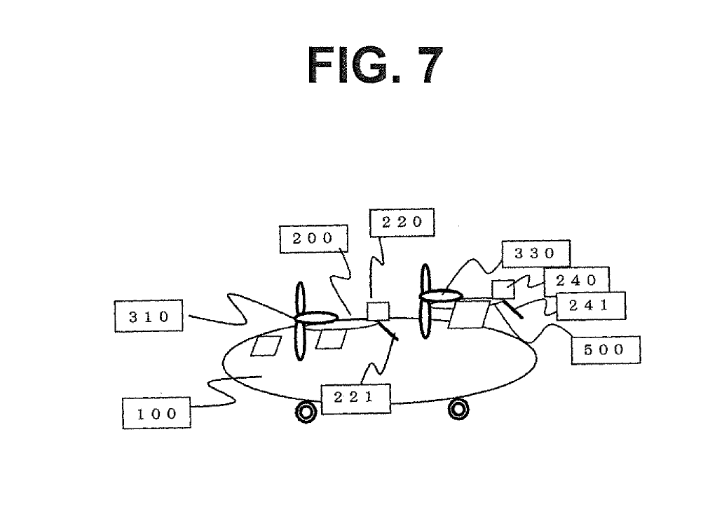

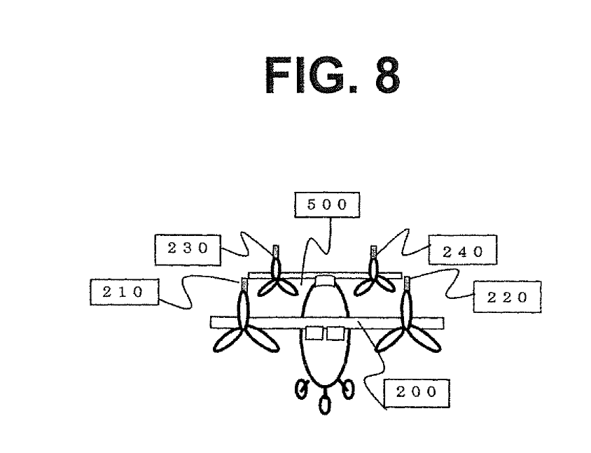

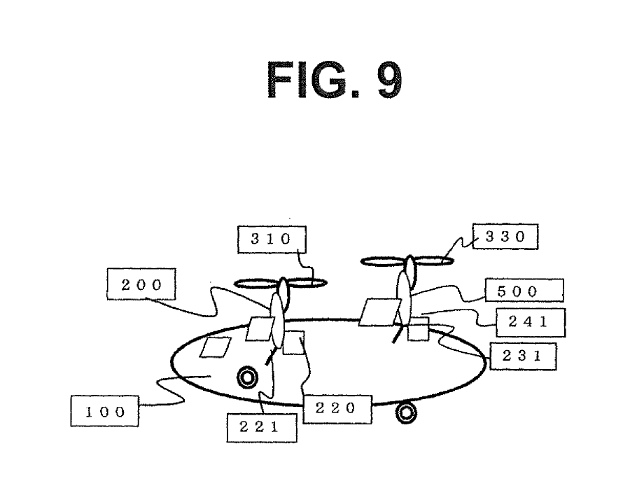

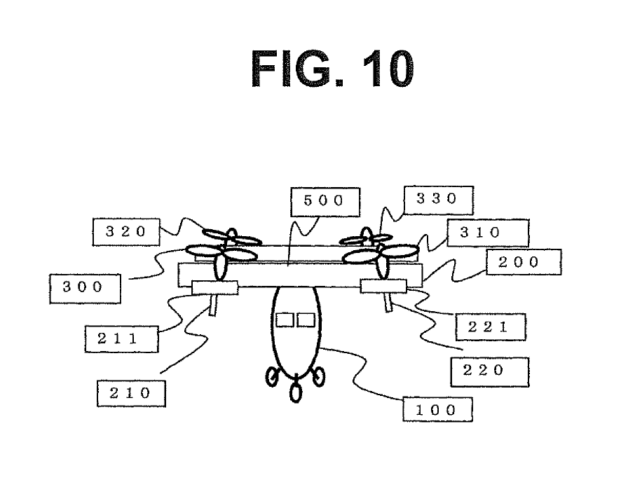

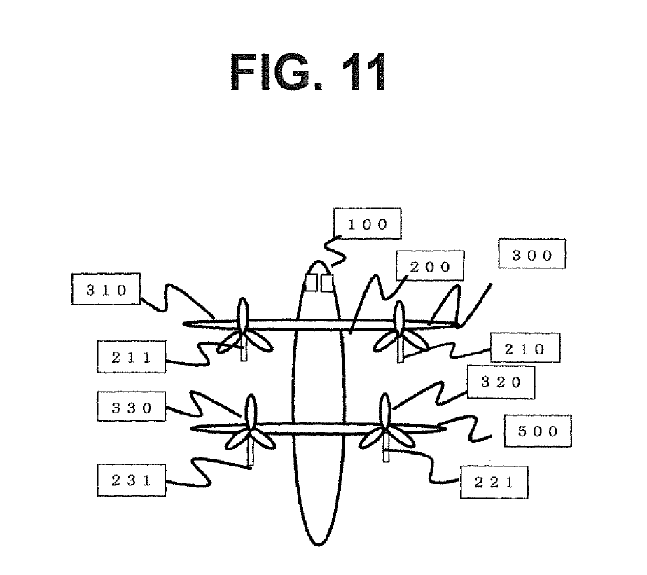

FIG. 5-FIG. 11 are illustrating second Embodiment relative to a aircraft having two wings, FIG. 6 is the schematic plan view thereof, FIG. 7 is the schematic side view thereof, FIG. 8 is the schematic front view thereof, FIG. 9 is the schematic side view in the hovering state, FIG. 10 is the schematic front view in the hovering state, and FIG.11 is the schematic plan view in the hovering state.

The same sign is given to the same component in FIG. 1-FIG. 5 so that duplicated illustration may be omitted but that the aircraft of the present Embodiment has two wings is different from the aircraft of first Embodiment. Because depending on the load to the aircraft, two wings may be in case preferable.

Referring to FIG. 6-FIG. 11, an aircraft according to the present Embodiment comprises first main wing 200 having a right wing and a left wing installed to the front of the airframe 100 and the top of an airframe 100, second main wing 500 having a right wing and a left wing installed to the rear of the airframe 100 and the top of the airframe 100, engines 300, 310, 320, 330 positioned approximately in the center position in the length direction of each right wing and left wing of firs main wing 200 and second main wing 500, flaps 211, 221, 231, 241 installed in the rear of each engine 300, 310, 320, 330 and operative to control nose-up/nose-down, and rudders 210, 220, 230, 240 installed in the rear of each engine 300, 310, 320, 330 and operative to control traveling direction of the airframe 100.

According to the above constitution, the first main wing 200 and the second main wing 500 pivot integrally in the vertical and horizontal direction with engines 300, 310, 320, 330; flaps 211, 221, 231, 241; and rudders 210, 220, 230, 240 as well as Embodiment 1. In addition, the first main wing 200 is installed in the one third front of the airframe 100 and the second main wing 500 is installed in the one third rear of the airframe 100.

In addition, referring to FIG. 7, a mounting position (height) of the first main wing 200 and the second main wing 500 are different, and the second main wing 500 is installed in the higher position than the height of first main wing 200. Should the heights are the same, jet-wind from engines 300, 310 of the first main wing 200 strikes engines 320, 330 of the second wing 500 so that jet-wind from engines 300, 310 of the first main wing 200 can be erased.

Further, referring to FIGs, in the case of two wings, no horizontal tail wing and tail wing rudder are not installed. Because the second main wing 500 functions as a horizontal tail wing and each rudder 210, 220, 230, 240 function as a rudder.

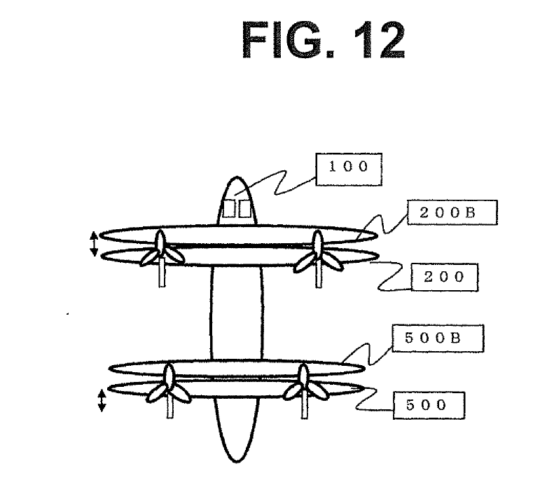

FIG. 12 is an alternative Embodiment of an aircraft of second Embodiment having two wings.

Referring to FIG., the first main wing 200 and the second main wing 500 are movable forward and backward approximately 1 m relative to the airframe (movement between the position of sign 200 and the position of 200B or between the position of sign 500 and the position of 500B). Accordingly, an effectively stable attitude can be ensured during low-speed flight and hovering and for balancing of lord weights).

### Third Embodiment

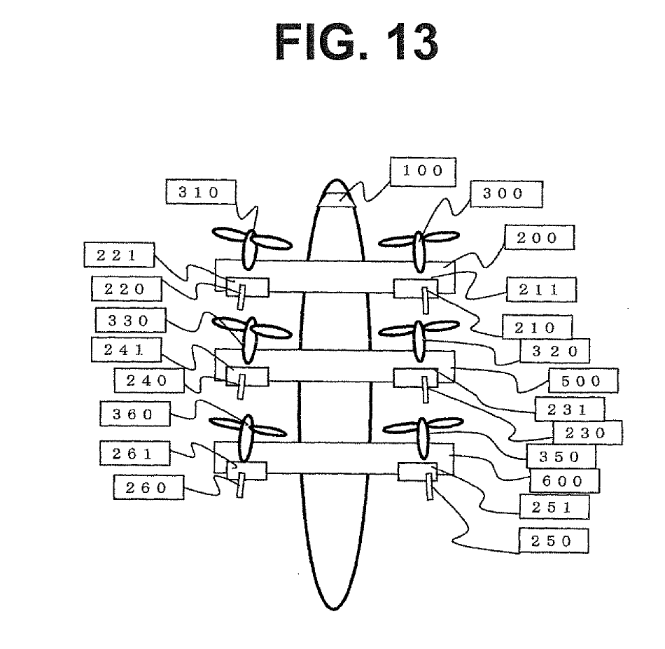

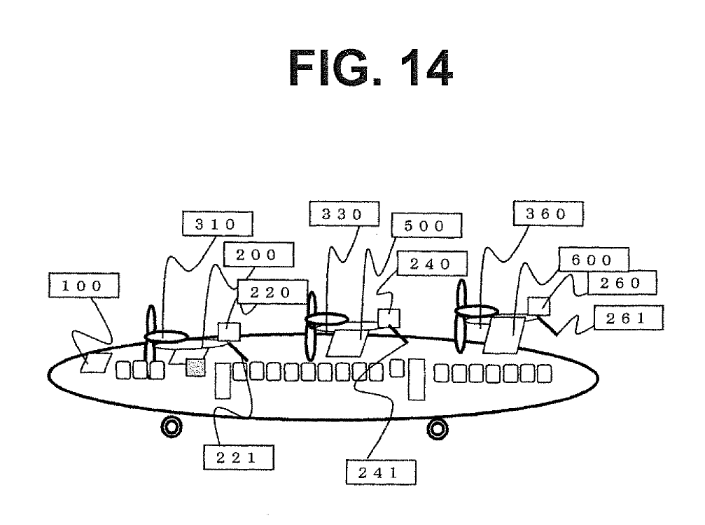

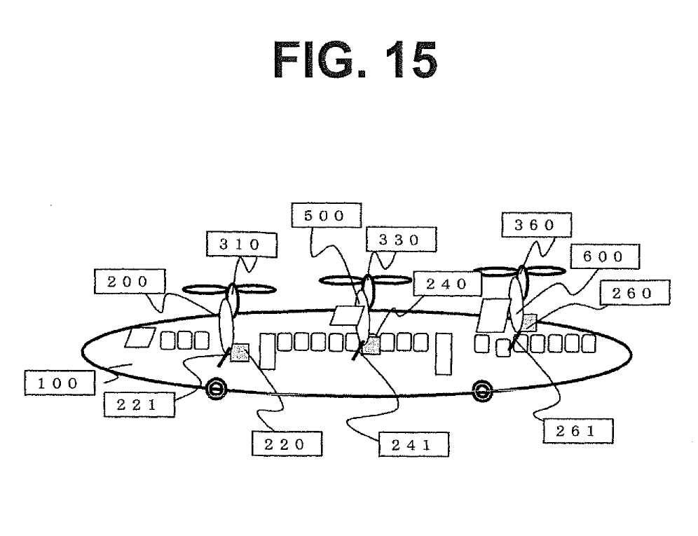

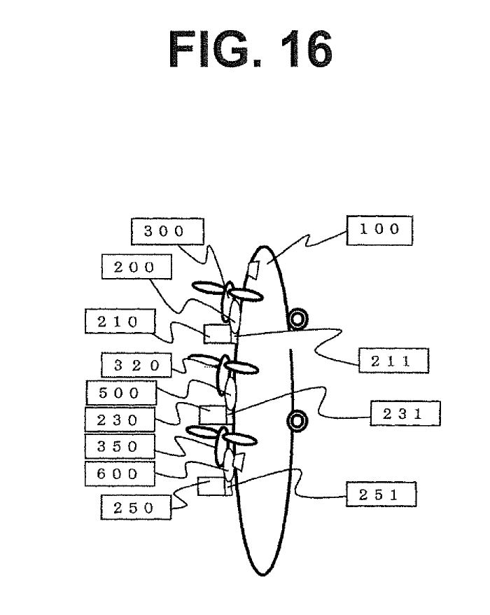

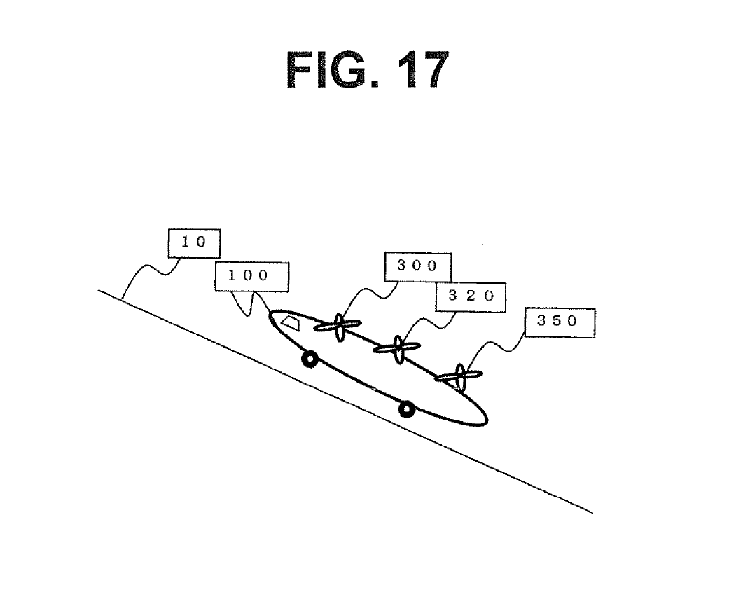

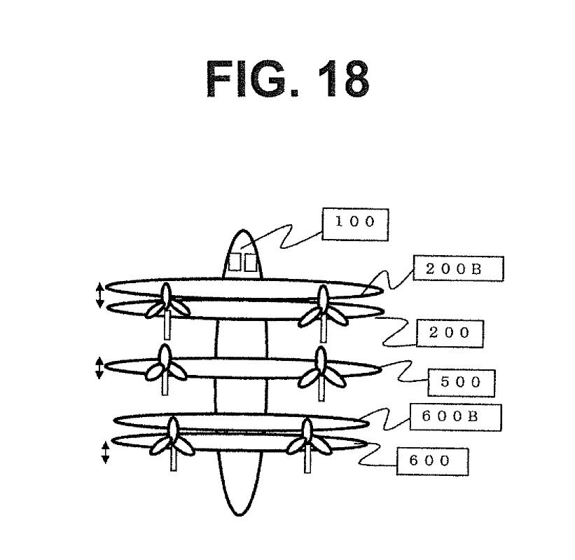

FIG. 5-FIG. 19 are illustrating third Embodiment relative to a aircraft having three wings, FIG. 13 is the schematic plan view thereof, FIG. 14 is the schematic side view thereof in the horizontal flight, FIG. 15 is the schematic side view in the hovering state, FIG. 16 is the side view in the hovering state in the standing attitude, and FIG. 17 is the view illustrating that the airframe can land on the steep slope or make Harrier Flight parallel to the slope. FIG. 18 is illustrating that three wings are movable forward and backward relative to the airframe.

The same sign is given to the same component in FIG. 1-FIG. 12 so that duplicated illustration may be omitted but that the aircraft of the present Embodiment has three wings is different from the aircraft of first and second Embodiments. The reason for adoption of three wings airframe is that in the case of one or two wings, the front and rear of the airframe affected by winds from a variety of direction of the airframe and the weight balance move easily up-and-down, and in addition, the flap is installed away from the engine and therefore winds from the wind jetting devices installed to right and left sides of the airframe jets vertically downward during Harrier Flight like hovering so that the airframe can be unstable against wind. Further, because depending on the load to the aircraft, passenger transportation, rescue activity and military activity, three wings may be preferable in case. Further, in some cases, three wings may be preferable to ensure balance e.g., attitude, lift force and accuracy of operation different from the case of the aircraft according to first and second Embodiments.

Referring to FIG. 13-FIG. 18, an aircraft of the present Embodiment comprise; a first main wing 200 having right and left wing installed to the top of an airframe 100 in the front of the airframe 100, a third main wing 500 having right and left wing installed to the top of an airframe 100 in the center of the airframe, a second main wing 600 having right and left wing installed to the top of an airframe 100 in the rear of the airframe 100, engines 300, 310, 320, 330, 350, 360 positioned approximately in the center position in the length direction of each right wing and left wing of first main wing 200, third main wing 500 and second main wing 600, flaps 211, 221, 231, 241, 251, 261 installed in the rear of each engine 300, 310, 320, 330, 350, 360 and operative to control nose-up/nose-down, and rudders 210, 220, 230, 240, 250, 260 installed in the rear of each engine 300, 310, 320, 330, 350, 360 and operative to control traveling direction of the airframe 100.

According to the above constitution, the first main wing 200 and the third main wing 500 and the second main wing 600 pivot integrally in the vertical and horizontal direction with engines 300, 310, 320, 330, 350, 360; flaps 211, 221, 231, 241, 251, 261; and rudders 210, 220, 230, 240, 250, 260 as well as Embodiment 1 and Embodiment 2. In addition, the first main wing 200 is installed in the one third front of the airframe 100, the third main wing 500 is installed near the center of the airframe 100 and the second main wing 600 is installed in the one third rear of the airframe 100.

In addition, referring to FIG. 14, a mounting positions (height) of the first main wing 200, the third main wing 500 and the second main wing 600 are different, and the third main wing 500 and the second main wing 600 is installed in the higher position than the height of first main wing 200, and the second main wing 600 is installed in the higher position than the height of the third main wing 500. Should the heights are the same, jet-wind from engines 300, 310 of the first main wing 200 strikes engines 320, 330 of the third wing 500, and jet-wind from engines 320, 330 of the third main wing 500 strikes engines 350, 360 of the second wing 600 as turbulence.

Further, referring to FIGs, in the case of two wings or three wings, no horizontal tail wing and tail wing rudder are not installed. Because the third wing 500 and the second main wing 600 functions as a horizontal tail wing and each rudder 210, 220, 230, 240, 250, 250 function as a rudder.

FIG. 16 is a side view illustrating the airframe 100 that is vertically hovering or rising. Since six jet-wind devices are installed to three wings, thrust forces substantially increase so that standing flight attitude can be operative, effectively stable attitude from standing attitude hovering to horizontal rotation or horizontal move as is standing attitude or forward-and-backward and right-and-left operation from standing attitude can be ensured by operation of six wings, operative six flaps and rudders, and referring to FIG. 17, landing and waiting on the steep slope or parallel flight to the slope can be operative.

FIG. 18 is an alternative Embodiment of an aircraft of third Embodiment having three wings.

Referring to FIG., the first main wing 200 and the second main wing 600 are movable forward and backward approximately 1 m relative to the airframe (movement between the position of sign 200 and the position of 200B or between the position of sign 600 and the position of 600B) while sandwiching the third main wing 500. Accordingly, an effectively stable attitude can be ensured during low-speed flight and hovering accurate operation and for balancing of lord weights.

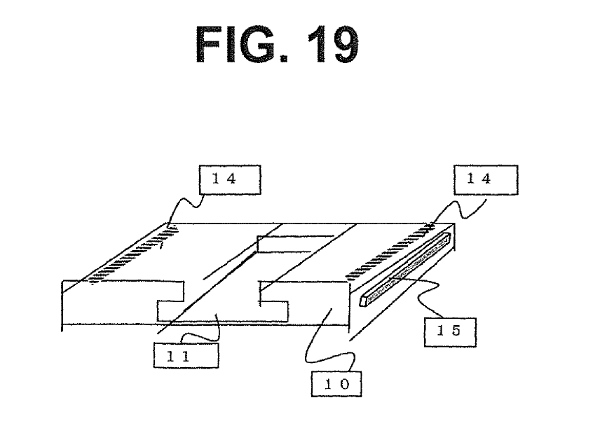

FIG. 19 is a view illustrating a moving device to move vertically the main wing installed to the top of the airframe from the horizontal plane. Referring to Fig., the movable device 10 comprises a reverse T-shape groove 11 in the cross section view thereof, the gear groove 14, and the guide rail 15.

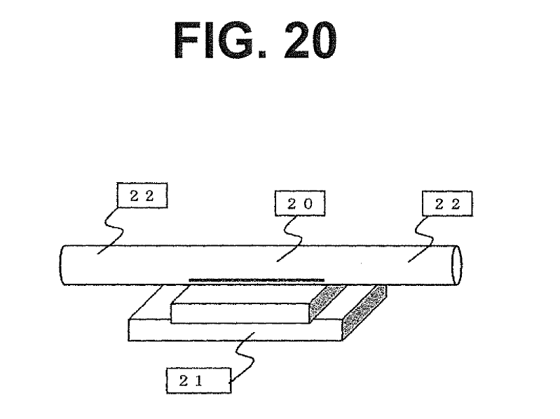

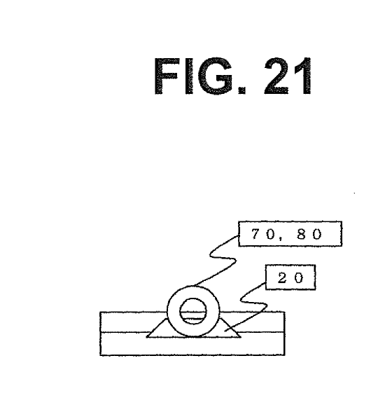

FIG. 20 and FIG. 21 are illustrating the base unit 20 inserted to the groove 11, and FIG. 20 is a perspective view thereof and FIG. 21 is a side view thereof. Referring to FIG. 20, the base unit 20 comprises a seat unit 21 and a wing support module 22 that supports the wing. Referring to FIG. 21, the wing support module 22 includes a hollow passing through in the length direction. The wing is shaft-supported by utilizing the unit.

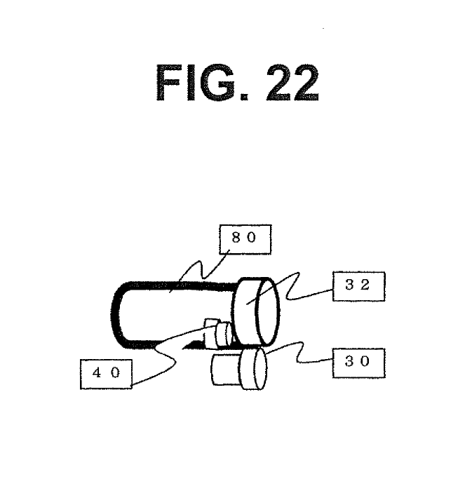

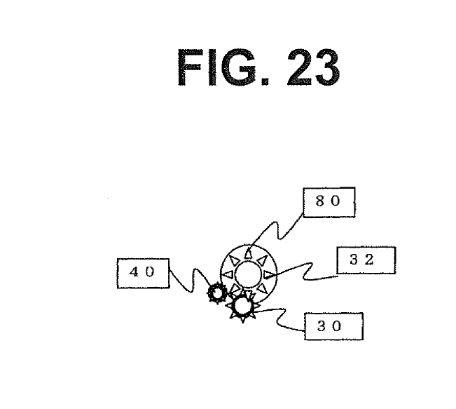

FIG. 22 is a view illustrating the positional relationship in between a wing mounting module 80 inserted and engaged to a wing support module 22, a gear with motor 32 installed to the wing mounting module, a gear with motor 30 to change the wing angle by engaging with the motor and a gear with motor 40 to move the wing position back and forth and FIG. 23 is a side view thereof.

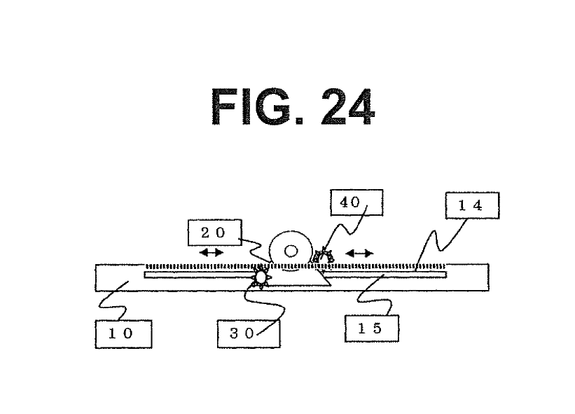

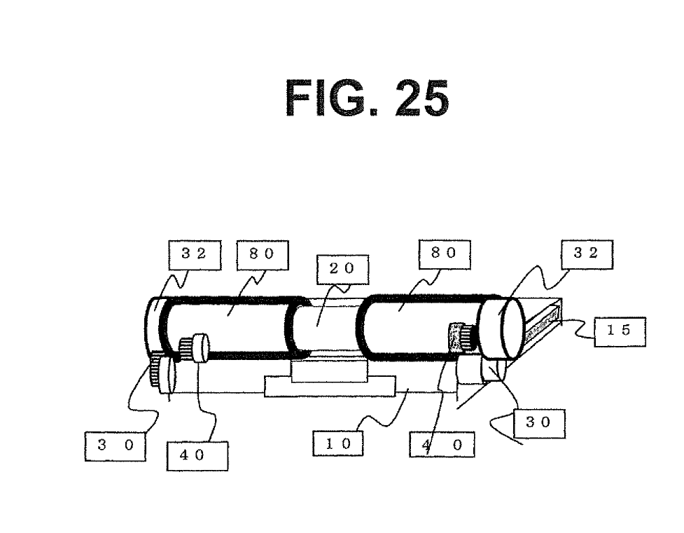

FIG. 24 is a side view illustrating the state in which each motor is mounted to the movable device 10. Referring to Figs., the motor with gear 40 gears to the gear groove 14 and rotates to move forward and backward. FIG. 25 is a perspective view illustrating the movable device 10 and the mounting state of motors 30, 32, 40.

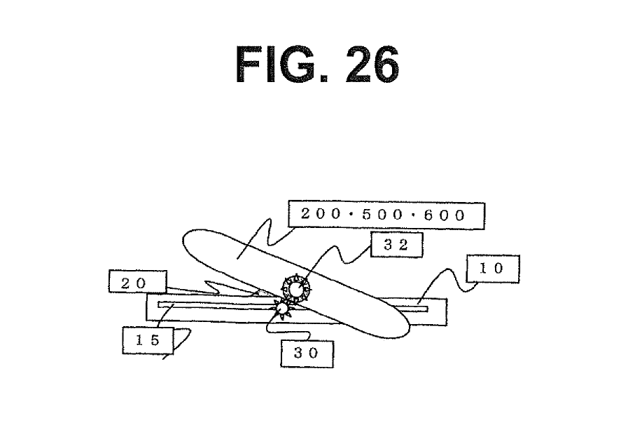

FIG. 26 is a view illustrating the state in which wings 200, 600, 500 are mounted to the movable device and operative. Referring to FIG., an angle of wings 200, 600, 500 is changed by the motors 30, 32 and, not illustrated in FIG., the motor 40 allows wings 200, 600, 500 to travel forward and backward.

### Third Embodiment

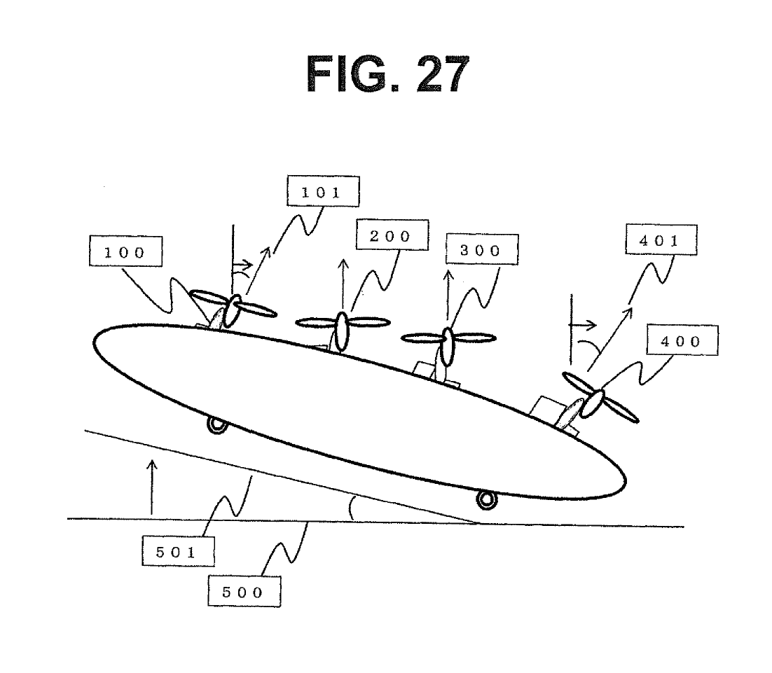

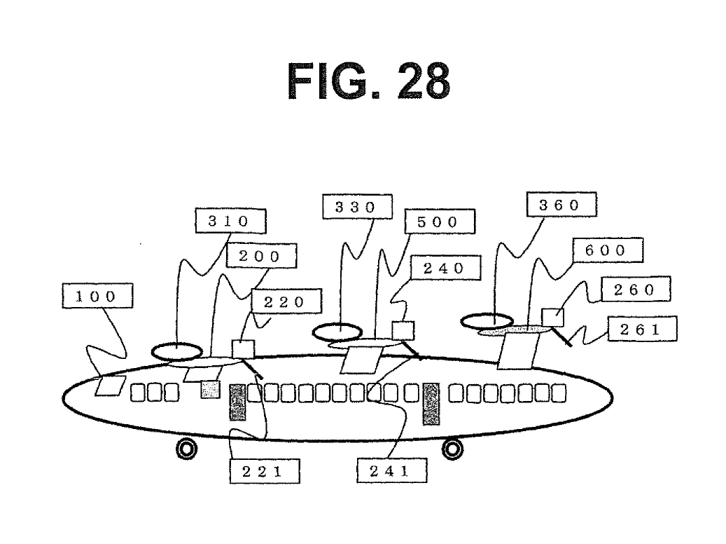

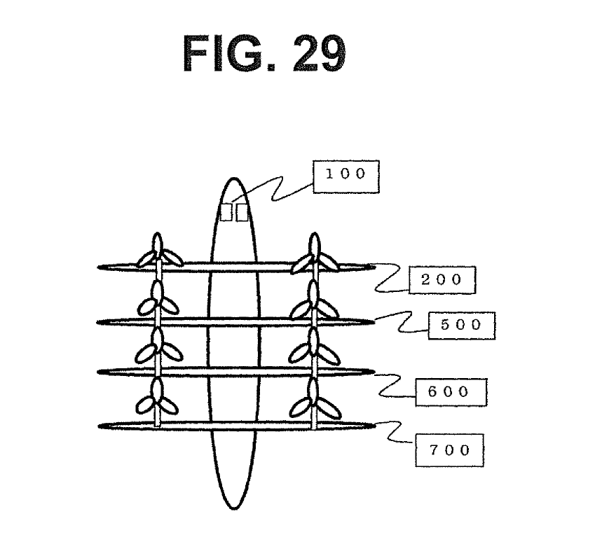

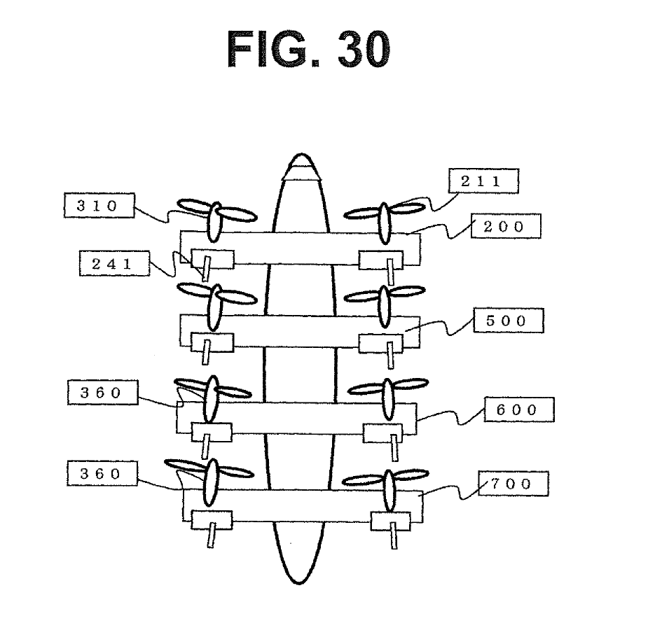

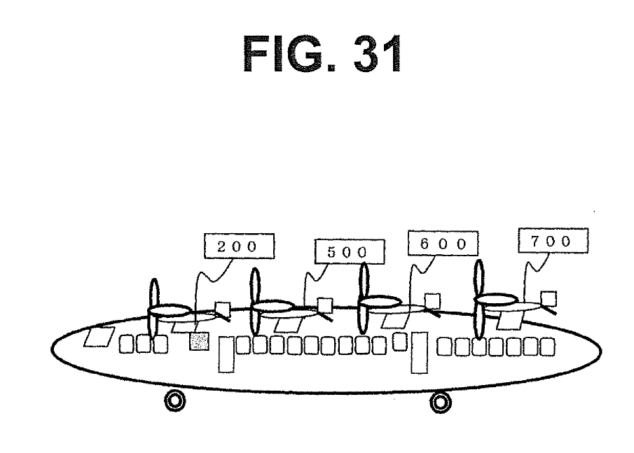

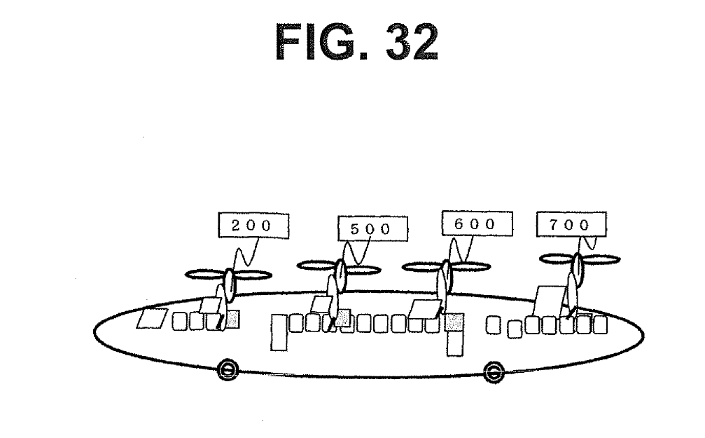

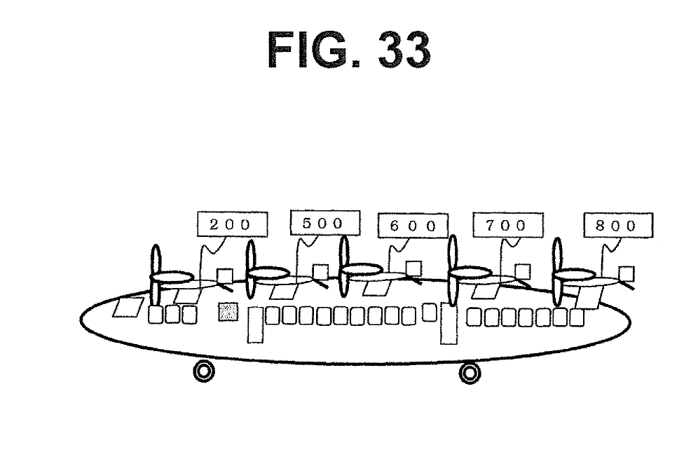

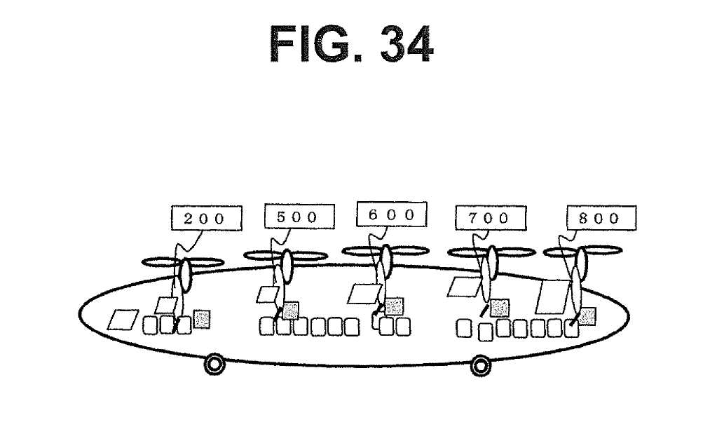

FIG. 27-FIG. 34 is an alternative Embodiment of a vertical takeoff and landing aircraft of third Embodiment. FIG. 27 is a view illustrating behavior of each wing when the airframe is changed with any angle from the horizontal plan to the vertical state. FIG. 28 is a view illustrating a jet system. FIG. 29 is a schematic plan view illustrating the hovering state when 4 wings are applied. FIG. 30 is a schematic plan view illustrating the horizontal flight when 4 wings are applied. FIG. 31 is a schematic side view illustrating the horizontal flight when 4 wings are applied. FIG. 32 is a schematic plan view illustrating the hovering state when 4 wings are applied. FIG. 33 is a schematic side view illustrating the horizontal flight when 5 wings are applied. FIG. 34 is a schematic view illustrating that an aircraft having 5 wings conducts takeoff and landing on water and is in the hovering attitude.

According to third Embodiment, the present invention provides a vertical takeoff and landing aircraft of the present invention to achieve the above purposes comprises: more than 3 but less than 5 wings that are installed to the top end of the airframe; wherein the plan part of each wings is movable from horizontal to vertical direction; a hybrid reciprocal engine or a turboprop jet engine that is installed between the airframe and the tip of each wing, a rudder and a flap installed near right behind each engine, wherein the engine is installed to the same wing; each sensor that is installed to each movable wing so as to operatively detects the direction of the airframe, nose-up and nose-down and rotation and so forth; a control unit that controls the attitude based on the sensor's information, and then each control unit pivots.

Further, the present invention provides the vertical takeoff and landing aircraft comprises: each engine that is positioned approximately center position in the length direction from the airframe connection unit of first, second, third, fourth and fifth wings having right and left wing installed to the top of the airframe to the tip of the wing; flaps that are installed near right behind each engine and controls operatively nose-up, nose-down and direction of the airframe; rudders that are installed near right behind each engine and controls operatively the traveling direction of the airframe; wherein first, second, third, fourth and fifth wings pivot integrally with engines, rudders and flaps in the horizontal direction or vertical direction.

Further, the present invention provides the vertical takeoff and landing aircraft comprises: three and more plural wings installed to the top of the airframe are in place at the optimal position from front to rear of the airframe and extending wings both sides of the airframe body, wherein wings are movable, increase further buoyancy and operative as a balance axis of installed neat the center of the airframe so that a superior stability is ensured.

Further, the present invention provides the vertical takeoff and landing aircraft comprises all wings of each airframe having a jet-wind generation device.

Further, the present invention provides that in the case of the vertical takeoff and landing aircraft comprising more than two plural wings, wherein each wing can be operative independently from other wings.

Further, the present invention provides that in the case of the vertical takeoff and landing aircraft comprising more than two plural wings, wherein power output from the engine installed to each wing can be operative independently from other wings and every wing.

Further, the present invention provides the vertical takeoff and landing aircraft comprises a blade that is capable of increasing and decreasing thrust or buoyancy by changing blade's angle during flight as a helicopter.

Further, the present invention provides the vertical takeoff and landing aircraft comprises a plurality of wings that are extending both side of the airframe respectively, wherein a engine is respectively installed to the center of all right side wing and left side wing.

Further, the present invention provides the vertical takeoff and landing aircraft comprises any wings that can be operative to change the angle within 100 degree in the horizontal and vertical direction of the airframe.

Further, the present invention provides the vertical takeoff and landing aircraft comprises any wings that can be operative to change the angle independently each other.

The present invention provides the aircraft of the present invention having the hybrid thrust device combined with a motor can obtain a big torque that allows the motor alone to provide the thrust force for few minutes during taking off and landing and for a few minutes after takeoff.

The present invention provides the aircraft comprising more than three wings having twin-engines, which are installed in the front, the intermediate and the rear of the airframe, ensures the weighted center of front and rear of airframe in the center of airframe.

A parallel system is preferable so as to be operative quietly only with the motor even for a short period of time despite available parallel system and split system relative to the hybrid structure.

The present invention provides the aircraft comprising more than three and less than five wings having twin-engines ensures the weighted center of front and rear of airframe in the center of airframe and is capable of loading a large load of the airframe.

The present invention provides the aircraft comprises a plurality of each sensor including a GPS, a gyro sensor, a proximity sensor, an altitude sensor, a speed sensor, a camera and so forth to collect each data, which are installed to the main body and the wings of the airframe.

The present invention provides the aircraft is operative to control each data of the GPS, the gyro sensor, the proximity sensor, the altitude sensor, the speed sensor, the camera and so forth by a computer; to simplify each flight-control device; and to achieve instantly and accurately processing the large data that are not understandable by human capability include the position, the airframe attitude, the speed, the height, the distance from an obstacle, all directional images of the airframe.

The present invention provides the aircraft that can be small and light and operative with high rotative speed engine due to installed plural engines.

The present invention provides the aircraft having a high rotative speed engine for an aircraft, wherein the engine is so as to fly in the high sky.

The present invention provides the aircraft having a battery charging system, wherein both a power generator installed to the engine and a plug-in charger on the ground can be used.

The present invention is characterized in that an engine is installed to all wings and one or two wings are at least and a purity of wings, three, four and five wings are installed.

The main body of the aircraft is a streamline shape that is less resistive.

According to the present invention, more than two movable wings are in stalled to the airframe, the turboprop engine or reciprocal engine is installed to he center of each right and left wing, the aircraft having an engine is a hybrid system operative with a motor, a power generator that is installed to the engine, the airframe comprises a high performance and large capacity rechargeable battery such as lithium so that lesser power output from the engine or using only the motor thrust force can provide a less noisy or quiet takeoff and landing aircraft, and takeoff and landing using a heliport in the city or residential area can be operative based on less noise effect, more than three wings having a twin engine are installed, a wing having lifting effect as an axis in the center of the front and the rear of the airframe is installed to the center of the airframe, stabilization of the airframe attitude can be obtained, the flight speed can reach 700 Km/hour as well as an airplane, and also the height can be 10,000 m as well as the airplane, further hovering at height 10,000 m can be operative, adoption of more than three wings allows gliding flight, power output from a number of engines and motors allows growing in size, and allows hovering at 10 m altitude, flying at any flight speed in the high and low altitude at up to 700 km/hour, hybridization and speeding up allows a long-range flight, adoption of more than three wings allows takeoff from and landing to water that requires high power output and being operative in the turbulence from any directions, a variety of sensors allows an unmanned flight.

Further, the aircraft will be large and capability and controllability thereof can are improved dramatically with a variety of sensors and many engines/wings/rudders/flaps so that the high-speed train requiring a vast infrastructure investment may not be needed and a safe aircraft can be provided as a moving vehicle in near future.

Further, when takeoff from water surface and the airframe is in the horizontal state, the contact area between the airframe body and water surface is maximal and should the body rises with the horizontal attitude, the surface tension is maximal so that a large energy is needed for the body to leave water surface, but providing the front of the airframe body is lifted 20 degree, 30 degree or 45 degree, the contact area between the airframe body and water surface decreases and also the surface tension between the airframe body and water surface decreases and then rising from water surface will be easy.

Further, the airframe in the hovering state,which is maintained as the horizontal state, can change the attitude thereof to the vertical direction to attach to the wall to the building for the rescue from the high rise building and to the required attitude of the airframe body in vertical or tilted attitude for the rescue or other works in the tilted area of mountains and so forth.

Further, as a common-sense theory, risk management capability for the aircraft having a plurality of wings, in which an engine is installed to each wing, can increase remarkably based on controlling each wing relative to the three wings aircraft compared to risk management capability of the single wing aircraft against sudden turbulence so-called down force during normal air-cruise.

Further, the inventor confirmed using the scale model, in which when all engines of the aircraft having a plurality of wings, in which an engine is installed to each wing (e.g, experimental example with three wings), are stalled during flight, a gliding flight was operable.

Further, one of purposes of the present invention is to ensure high buoyancy relative to the aircraft with a plurality of wings in which an engine is installed to each wing and such high buoyancy allows the aircraft to fly 5-10 m above water surface and in-between trees and 10 m above the farm land, i.e., in very low altitude with a high-speed.

Further, relative to the aircraft with a plurality of wings in which an engine is installed to each wing, a aircraft having 4 engines with two wings has absolutely more thrust force than the aircraft having two engines with one wing and the high-speed flight is operative, and providing three wings, the aircraft therewith can fly in higher speed than one with the two wings and can be more operative to keep the operative airframe attitude.

### Another Alternative Embodiment

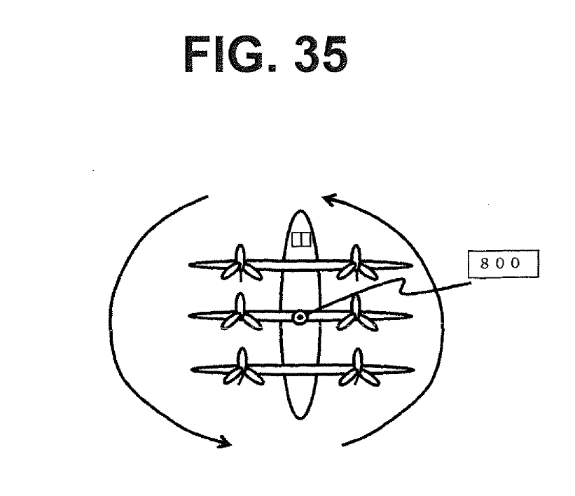

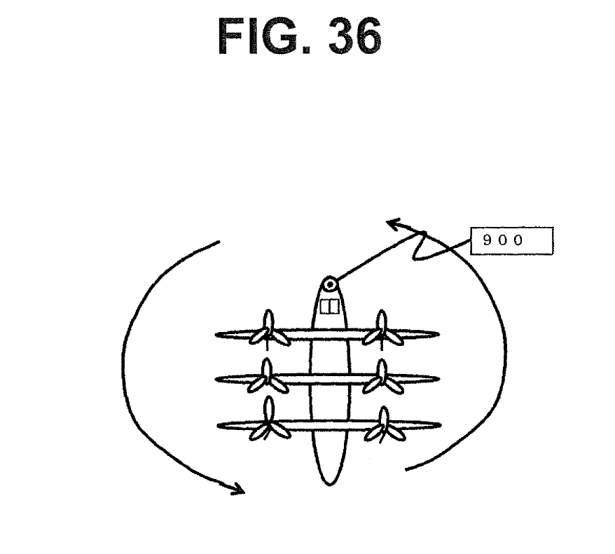

FIG. 35 and FIG. 36 are schematic views illustrating the airframe horizontally rotating, FIG. 35 is a schematic view illustrating the airframe horizontally rotating around the center axis of the airframe, and FIG. 36 is a schematic view illustrating the airframe horizontally rotating around the tip axis of the airframe during hovering.

Referring to FIG. 35, in the case of three wings and small rudders adopted for the wing at the tip and at the rear of the airframe, the rudder is operative to allow the airframe in the hovering horizontally rotating in the arrow direction around the center axis 800 of the airframe. Further, referring to FIG. 36., the small rudder is operative to allow the airframe in the hovering horizontally rotating in the arrow direction around the tip of the airframe as the axis thereof.

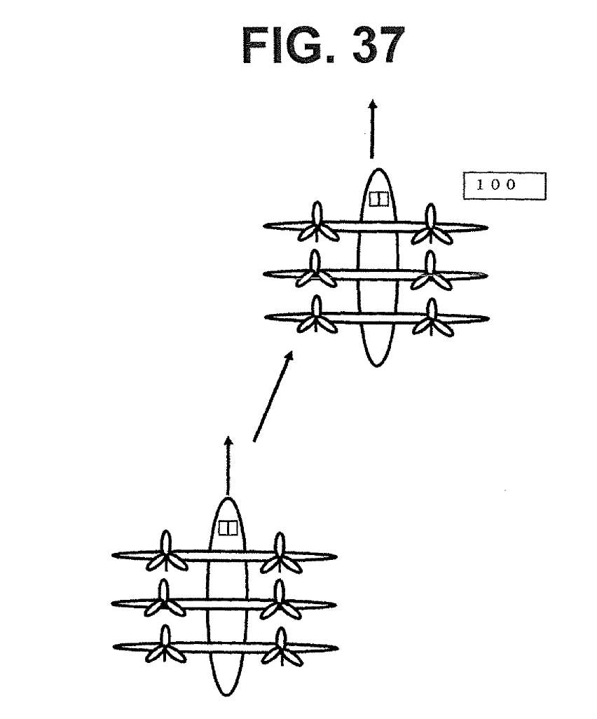

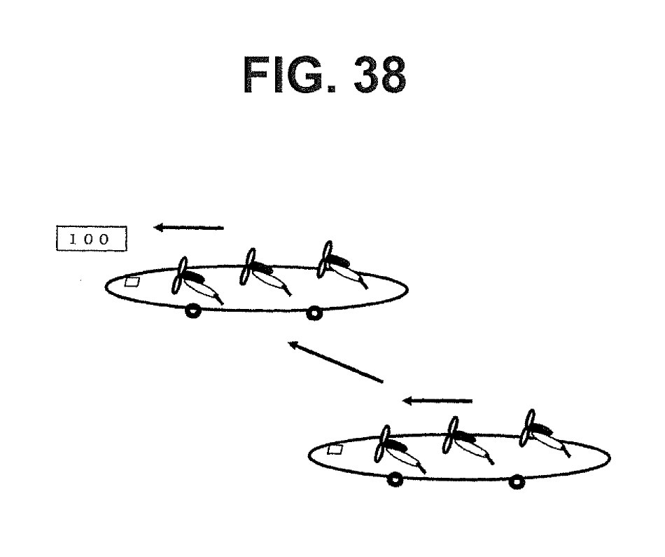

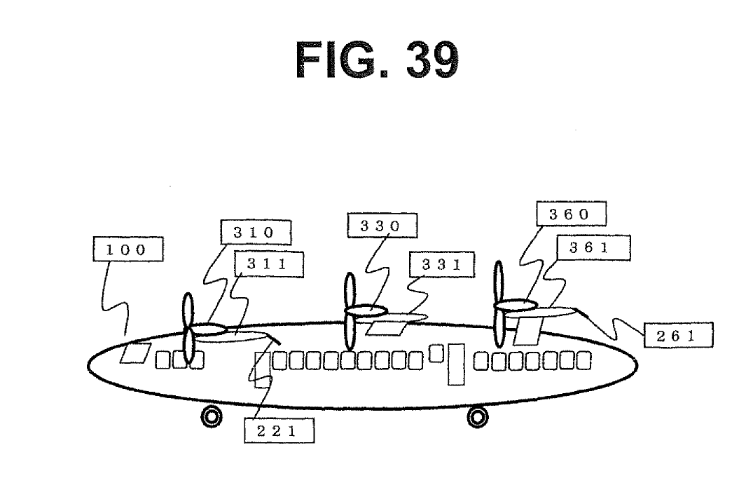

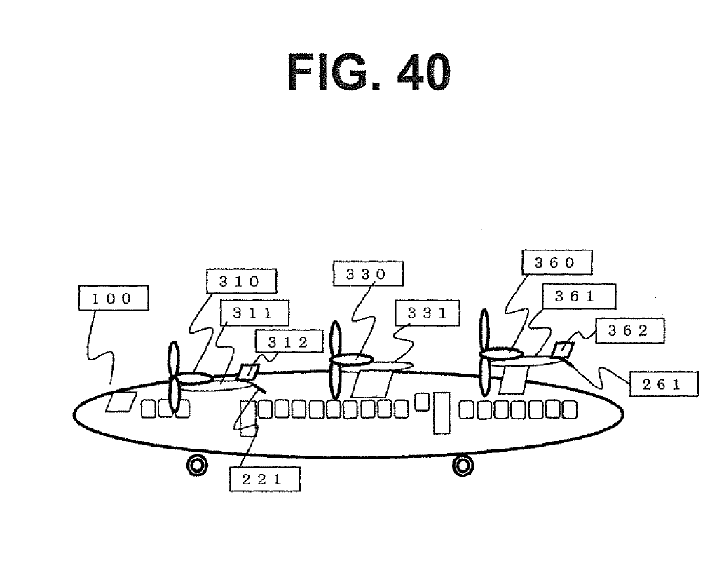

FIG. 37 is a schematic view illustrating the airframe moving in parallel to change the traveling trail without changing the airframe attitude, and the FIG. 38 is a schematic view illustrating the parallel rising when the airframe increase height while keeping a horizontal attitude. FIG. 39 is a schematic side view illustrating an airframe without a tail wing and a vertical rudder from a plurality of movable wings, FIG. 40 is a schematic side view illustrating an airframe in which small rudders 312, 362 are installed to the front wing 311 and the rear wing 361 of the airframe. In FIG., sign 311 corresponds to first wing, sign 330 corresponds to second wing, sign 311 corresponds to third wing, signs 310, 330, 360 correspond to engines of first wing through third wing, and sing 221, 261 correspond to flaps.

FIG. 37 is a schematic view illustrating that the airframe having 3 wings and the front and rear wings with the small rudder, wherein the rudder and the flap are operative to change the moving trail to parallel without changing the airframe attitude in the case of moving straight forward. Further, referring to FIG. 38, the movable wings, rudders and flaps are operative to allow the airframe rising while maintaining the horizontal attitude. Further, referring to FIG. 30 and FIG. 40., the vertical tail rudder and the horizontal tail wing and/or a tail rotor are made in a small size and/or eliminated so that the airframe can maintain the best attitude regardless turbulence including side wind and upstream or downstream during runway takeoff and landing or vertical takeoff and landing takeoff and landing.

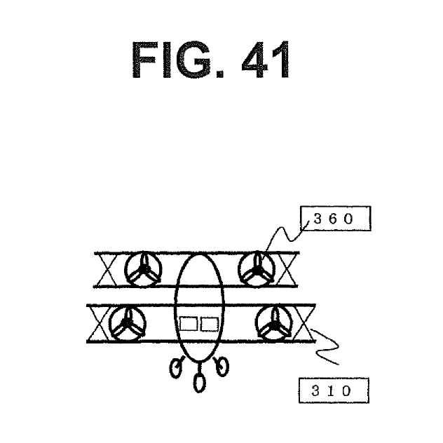

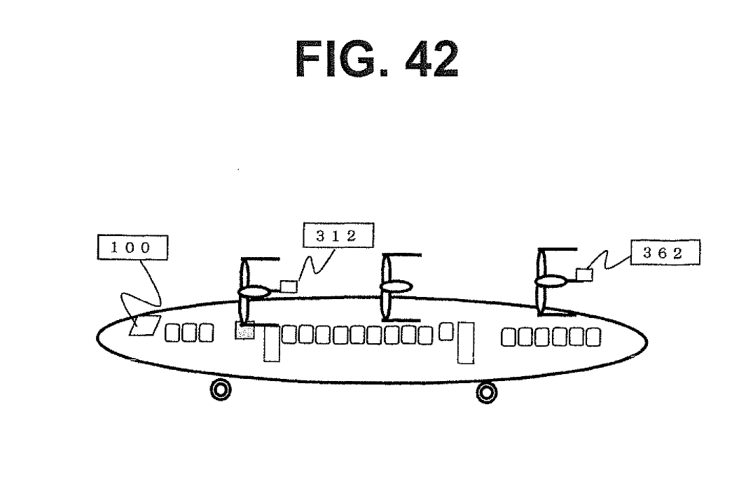

FIG. 41 is a schematic front view of Embodiment, wherein the engines 310, 360 installed to a plurality of variable and movable double wings, and FIG. 42 is a schematic side view illustrating an alternative Embodiment in which small rudders 312, 362 are installed to the right behind the engines 310, 360 of a plurality of variable and movable double wings.

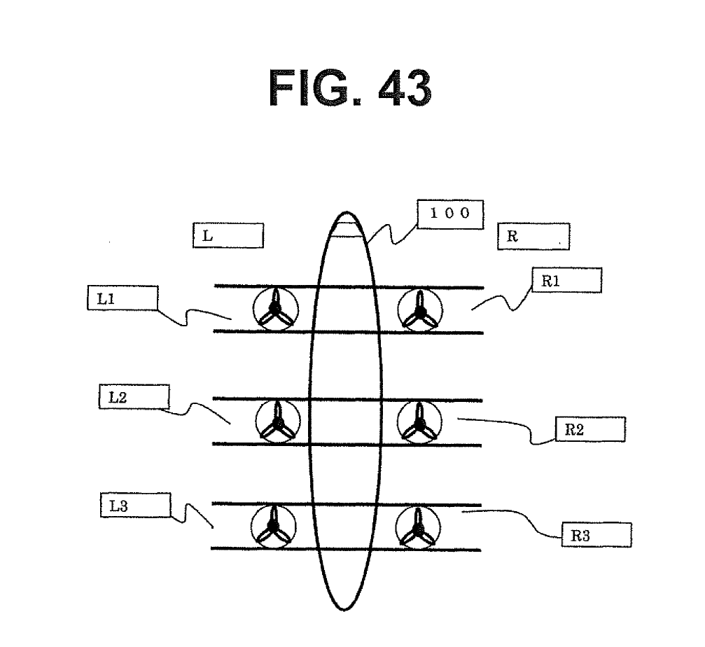

FIG. 43 is a schematic top view illustrating the airframe 100 in the hovering state, wherein jet-wind generation device is installed to a plurality of plan movable double wings (L1-L3, R1-R3).

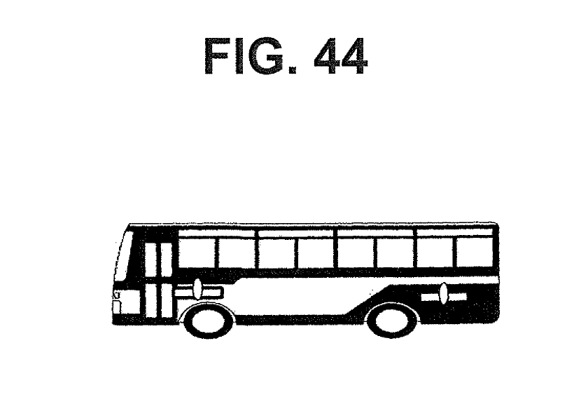

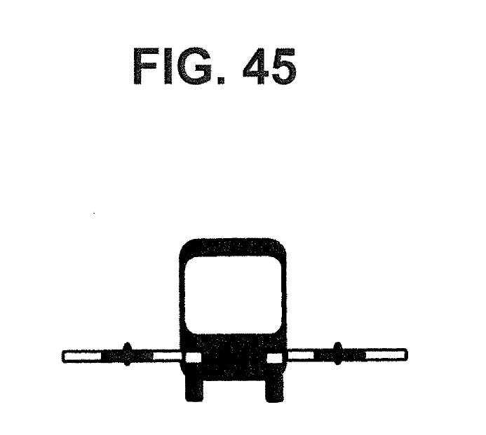

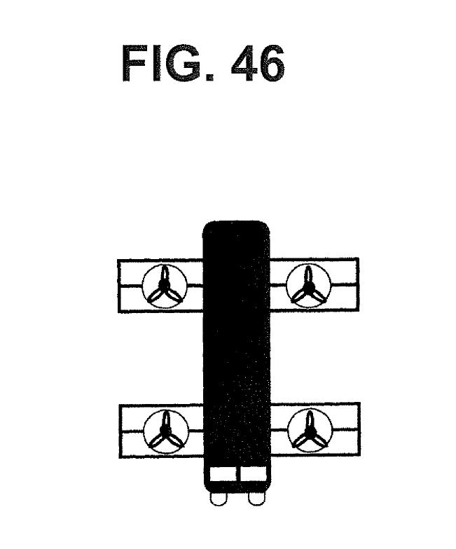

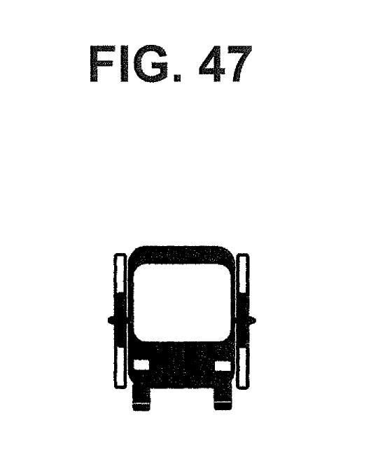

FIG. 44-FIG. 47 are views illustrating an alternative Embodiment in which the folding variable and movable wings are installed to a bus, FIG. 44 is a schematic side view illustrating that the wings are opened, FIG. 45 is a schematic front view illustrating an alternative Embodiment in which the folding variable and movable wings are installed to a bus. FIG. 46 is a schematic top view illustrating an alternative Embodiment in which the folding variable and movable wings installed to a bus are opened. FIG. 47 is a schematic front view illustrating an alternative Embodiment in which the folding variable and movable wings installed to a bus are opened.

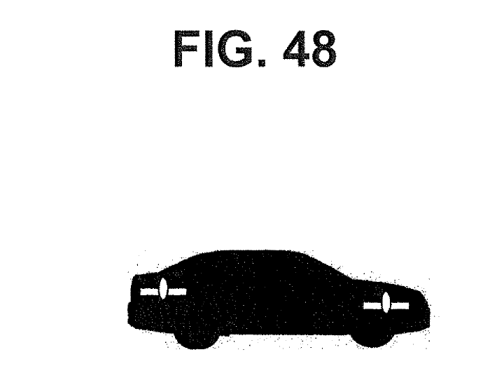

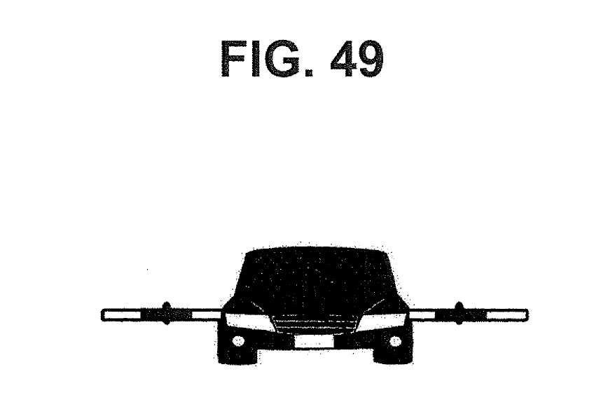

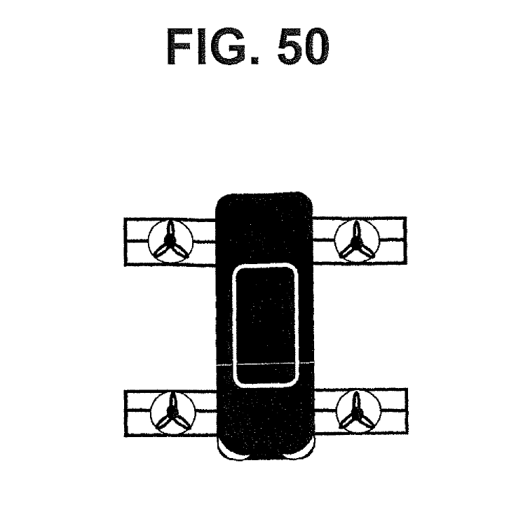

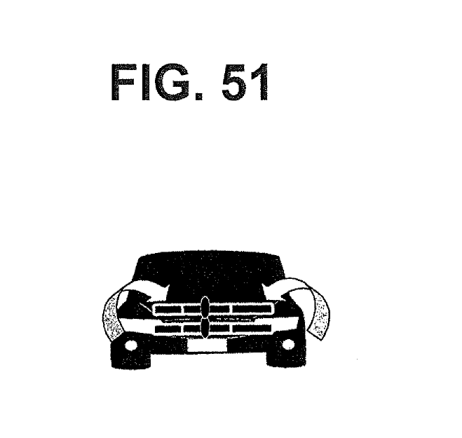

FIG. 48-FIG. 51 are schematic views of an alternative Embodiment in which the retractable, variable and movable wings are installed to a passenger car, and FIG. 48 is a schematic front view thereof. FIG. 49 is a schematic front view illustrating an alternative Embodiment in which the retractable and variable wings are installed to a passenger car. FIG. 50 is a schematic plan view illustrating an alternative Embodiment in which the retractable and variable wings are installed to a passenger car. FIG. 51 is a schematic front view illustrating an alternative Embodiment in which the retractable, variable and movable wings installed to a passenger car are retracted.

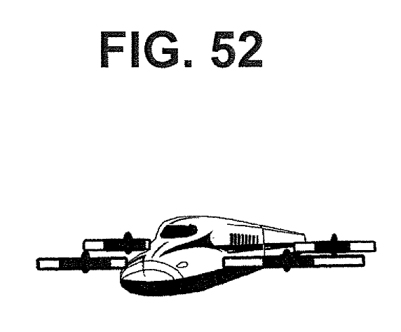

FIG. 52 is a schematic perspective view illustrating an alternative Embodiment in which the retractable and variable wings are installed to a flying boat.

### SUMMARY OF PRESENT EMBODIMENT

1. According to the present invention; first, second and third wings are selected and installed, heavy engines are installed to near the center of right and left wing of the airframe and focused to the weighted center of the airframe, rudders and flaps are installed near behind engines of the same wings, and the movable wings relative to angle and position thereof are installed, so that the airframe can obtain the best wind actions without being disturbed by the jet-wind from engines by changing the angle and position of wings on runway takeoff and landing and vertical takeoff and landing takeoff and landing. Further, it can correspond to the weight balance of the airframe. Accordingly, it can be stable in any flight states including low-speed, high-speed and acrobatic flight and safe flight and growing in size can be obtained.

2. According to the aircraft adopting the three wings of the present invention, the front wing of the airframe is installed in one third from the tip of the airframe or closer to the tip, the wing installed in the center of the airframe and the two third from the tip of the airframe or closer to the end of the airframe, and the wings can be moved approximately 1 m forward or backward on the airframe so that low-speed flight and hovering and balancing the load can be effectively ensured.

3. According to the aircraft adopting the three wings of the present invention, the wing installed in the center of the entire airframe can be moved approximately 1 m forward or backward on the airframe so that low-speed flight and hovering and balancing the load, and interlocking with the front wing and the rear wing and so forth can be effectively ensured.

4. According to the present invention, the wing to which the engine is fixedly installed inside from the tip of the wing can be movable from horizontal direction to vertical direction and the wing, the engine, the rudder and the flap are integrally movable in 100 degree so that even on nose-up in the vertical direction as well as in the horizontal direction the face of the engine and the face of the wing are interlocked and the minimum resistance plan of the wing against wind can be obtained, and thereby the air resistance can extremely decrease and lifting power diminishing prevention effect and turbulence prevention effect on the plan of the wing can be obtained so that the safe flight attitude can be ensured.

5. According to the present invention, the wing is installed to the top of the airframe and for example, if the propeller engine is used as a thrust machine, the space between the ground can be assured and the radius of the propeller can be made larger or the space from water surface can be obtained when the flying boat is taking off or landing.

6. According to the present invention, the flap is installed to the movable wing near the mounting module of the engine so that wind flow from the engine can be always utilized advantageously and can be used to control effectively the attitude corresponding to a variety of flight states. For example, when 2, 4 or 6 flaps are operative during Harrier Flight, the airframe can travel forward and backward and if either one of right and left flaps is operative, slow horizontal rotation can be obtained.

7. According to the present invention, the rudder installed right behind each engine is always positioned in the center of the wind flow from the engine in any flight attitudes so that the optimal attitude control can be effectively operative. For example, when 2, 4 or 6 flaps are operative during Harrier Flight, the airframe can travel to right and left and if either one of right and left flaps is operative, slow horizontal rotation can be obtained.

8. According to the present invention, 1, 2, or 3 main wings installed in the front and rear of the airframe are movable around 1 m forward or backward and the optimal balance can be controlled by a computer during flight based on the attitude control as to balance of the load, speed, turbulence so that unconventional safety can be ensured. Specifically, not only three main wings is movable from horizontal to vertical, but also is not fixed to the airframe and movable forward and backward so that flight balance can be ensured.

9. According to the present invention, among a plurality of wings, e.g., three or four, power output of the engine installed to each of the wing installed in the front of the airframe, the wing installed in the center of the airframe, and the wing installed in the rear of the airframe can be changed from wing to wing, and further if the wing angle can be changed, the desirable airframe attitude can be ensured, and if the speed of the airframe is expected to be decreased, the engine power output of the rear wing of the airframe can be shut off, and despite vertical takeoff and landing aircraft, a high-speed flight as if a propeller aircraft and a higher altitude flight than a propeller aircraft will be possible, and high rise building higher than 300 m in the world have been built and thereby the emergency rescue method can be effectively obtained, and needless to say, for military purposes, hovering at unusual high altitude flight higher than 10,000 m, unmanned aircraft carrying 20-30 missiles, and a high-speed bomber at very low altitude e.g., 50 m and a variety of rescue activities will be operable.

10. Further, it is not bright for the bullet train that requires very high cost infrastructure works including making tunnels and acquiring lands and high maintenance cost and it will result high transportation expenses, and to date LCC (low cost carrier) flight is available but the transportation to the far away airport is inconvenient; but from futuristic standpoints, when a vertical takeoff and landing aircraft capable of carrying 200 passengers at 800 km/hour in the flight range 1000 km (now called a heliplane aircraft) is operable, people can take the heliplane to the main station (station building heliport) in between each city and then take a local train from the main station to enjoy the travel. An aircraft to which the approach is inconvenient and a bullet train may be unnecessary and as result the aircraft of the present invention can be a revolutionary moving means for 22 century.

11. Further, according to the present invention, a vertical tail rudder and the horizontal tail wing and/or a tail rotor are made in a small size and/or eliminated so that the airframe can maintain the best attitude regardless turbulence including side wind and upstream or downstream during runway takeoff and landing or vertical takeoff and landing takeoff and landing.

12. In addition, a plurality of thrust machines are installed so that stable attitude control can be turned in reality by the thrust machines.

1. A vertical takeoff landing aircraft comprises:
movable wings that constitute a plurality of wings, wherein the plan part of each wing is movable from horizontal to vertical direction installed to the top of an airframe;
a jet-wind generation device installed to the plurality of wings operative to generate a jet-wind,
a rudder is operatively installed to a proximity right behind the jet-wind generation device and operatively controls a moving direction of the airframe and a flap is operatively installed to a proximity right behind the jet-wind generation device and is operative so as to control an up-and-down direction of the airframe,
a plurality of sensors operative to detect the direction/rising/down/rotation/position/airframe attitude/speed/altitude/distance to an obstacle is installed to each said movable wing, and
a control module installed to said airframe operative to conduct the attitude control based on the detected data by each sensor.

2. The vertical takeoff landing aircraft according to claim 1, wherein:
said jet-wind generation device is installed in the middle between said airframe and said plural wing tips.

3. The vertical takeoff landing aircraft according to claim 1, wherein:
said jet-wind generation device is a hybrid type reciprocating engine or a turboprop jet engine.

4. The vertical takeoff landing aircraft according to claim 1, wherein:
said jet-wind generation device further comprises:
a hybrid jet-wind generation device wherein said each engine and motor are used together.

5. The vertical takeoff landing aircraft according to claim 4, wherein:
said hybrid system is a parallel system and the motor alone can be operative in a short period of time.

6. The vertical takeoff landing aircraft according to claim 1, wherein:
said plural wings are each operative independently from other respective wings.

7. The vertical takeoff landing aircraft according to claim 1, wherein:
said jet-wind generation devices installed to the plural wings are operative independently from other wings respectively.

8. The vertical takeoff landing aircraft according to claim 1, wherein:
said plural wings are operative in a 100 degree angle upward from a horizontal direction to a vertical direction.

9. The vertical takeoff landing aircraft according to claim 1, wherein:
said plural wings are operative in any angle each with an individual angle relative to an initial position.

10. The vertical takeoff landing aircraft according to claim 1, wherein:
said sensors are selected from a group of sensors consisting of: a global positioning sensor (GPS), a gyro sensor, a proximity sensor, a altitude sensor, and a speed sensor.

11. The vertical takeoff landing aircraft according to claim 1 comprising:
an imaging device that is operative to take momentarily understandable images all around the airframe and is installed to said airframe.

12. The vertical takeoff landing aircraft, according to claim 3, wherein:
each said engine is a high rotative speed engine for an aircraft.

13. The vertical takeoff landing aircraft according to claim 1 further comprising:
batteries, wherein said batteries are installed to said airframe, and
wherein batteries are operatively charged by one of a generator installed to each engine, a generator-charge system, a plug-in charger, and a plug-in charging system on the ground.

14. The vertical takeoff landing aircraft according to claim 1, wherein:
a number of said installed wings is at least three.

15. The vertical takeoff landing aircraft according to claim 14 wherein:
when at least three wings are installed, at least one wing installed in a center position of the airframe is positioned operably shiftable from one to two meters toward either front or rear direction.

16. The vertical takeoff landing aircraft according to claim 15:
at least one of a small vertical tail rudder and a small tail rotor installed behind the jet-wind generation device in at least one of the very front wing and in the very rear of said airframe.

17. The vertical takeoff landing aircraft according to claim 16, wherein:
controls for at least one of an airframe attitude, a traveling direction and a traveling speed are conducted by controlling ones of said wings and a thrust force of a plurality of said jet-wind generation devices.

18. The vertical takeoff landing aircraft according to claim 1, further comprises retractable wings operatively installed to a side of a moving vehicle including at least one of a bus and an automobile.
